(19) United States
(12) Patent Application Publication
(10) Pub. No.: US 2016/0128043 A1
(43) Pub. Date: May 5, 2016

(54) DYNAMIC MOBILE AD HOC INTERNET OF THINGS (IOT) GATEWAY

(71) Applicant: QUALCOMM Incorporated, San Diego, CA (US)

(72) Inventors: Mohammed Ataur Rahman SHUMAN, San Diego, CA (US); Amit GOEL, San Diego, CA (US); Sandeep SHARMA, San Diego, CA (US); Ashutosh AGGARWAL, San Diego, CA (US)

(21) Appl. No.: 14/926,810

(22) Filed: Oct. 29, 2015

Related U.S. Application Data
(60) Provisional application No. 62/072,725, filed on Oct. 30, 2014.

(51) Int. Cl. H04W 72/04; H04W 36/00

(52) U.S. Cl. CPC H04W 72/044; H04W 36/0005; H04W 84/18

(57) ABSTRACT

The disclosure generally relates to a dynamic ad hoc gateway that can be configured to provide inter-network communication among different Internet of Things (IoT) networks (or subnetworks). For example, in various embodiments, connectivity and capability information may be advertised via a personal IoT network from a first potential gateway to a first device and other potential gateways and connectivity and capability information advertised from the other potential gateways may be similarly received at the first potential gateway via the personal IoT network. The connectivity and capability information advertised from the first potential gateway and the other potential gateways may then be evaluated to determine whether the first potential gateway is an elected gateway and a secure private network and an external interface from the secure private network may be established for one or more devices coupled to the elected gateway.

### CROSS-REFERENCE TO RELATED APPLICATION

The present Application for Patent claims the benefit of U.S. Provisional Application No. 62/072,725, entitled “DYNAMIC MOBILE ADHOC INTERNET OF THINGS (IOT) GATEWAY,” filed Oct. 30, 2014, assigned to the assignee hereof, and expressly incorporated herein by reference in its entirety.

### TECHNICAL FIELD

The various aspects and embodiments described herein generally relate to the Internet of Things (IoT), and more particularly, to a dynamic ad hoc gateway that may be used in a mobile IoT subnetwork and/or other IoT subnetwork having contextually dependent aspects to provide inter-network communication among different IoT networks and/or IoT subnetworks.

### BACKGROUND

The Internet is a global system of interconnected computers and computer networks that use a standard Internet protocol suite (e.g., the Transmission Control Protocol (TCP) and Internet Protocol (IP)) to communicate with each other. The Internet of Things (IoT) is based on the idea that everyday objects, not just computers and computer networks, can be readable, recognizable, locatable, addressable, and controllable via an IoT communication network (e.g., an ad hoc system or the Internet).

A number of market trends are driving development of IoT devices. For example, increasing energy costs are driving governments' strategic investments in smart grids and support for future consumption, such as for electric vehicles and public charging stations. Increasing health care costs and aging populations are driving development for remote/connected health care and fitness services. A technological revolution in the home is driving development for new “smart” services, including consolidation by service providers marketing ‘N’ play (e.g., data, voice, video, security, energy management, etc.) and expanding home networks. Buildings are getting smarter and more convenient as a means to reduce operational costs for enterprise facilities.

There are a number of key applications for the IoT. For example, in the area of smart grids and energy management, utility companies can optimize delivery of energy to homes and businesses while customers can better manage energy usage. In the area of home and building automation, smart homes and buildings can have centralized control over virtually any device or system in the home or office, from appliances to plug-in electric vehicle (PEV) security systems. In the field of asset tracking, enterprises, hospitals, factories, and other large organizations can accurately track the locations of high-value equipment, patients, vehicles, and so on. In the area of health and wellness, doctors can remotely monitor patients' health while people can track the progress of fitness routines.

As such, in the near future, increasing development in IoT technologies will lead to numerous IoT devices surrounding a user at home, in vehicles, at work, and many other locations. Due at least in part to the potentially large number of heterogeneous IoT devices and other physical objects that may be in use within a controlled IoT network, which may interact with one another and/or be used in many different ways, well-defined and reliable communication interfaces are generally needed to connect the various heterogeneous IoT devices such that the various heterogeneous IoT devices can be appropriately configured, managed, and communicate with one another to exchange information. Furthermore, because different IoT devices may be associated with one or more specific IoT networks and/or subnetworks based on need, attributes, and/or other suitable criteria, a well-managed IoT network will need to provide inter-network communication among different IoT networks and/or subnetworks that form a larger IoT network. For example, a particular home IoT network may include a personal IoT subnetwork (e.g., a smart phone, smart watch, laptop, health or activity sensors, etc.) and a car IoT subnetwork (e.g., the smart phone and/or other devices that are used in the car). Accordingly, many IoT subnetworks may be substantially mobile and dynamic and need to interact with external subnetworks in order to request and utilize contextually appropriate services. However, when IoT devices that belong to a particular IoT subnetwork interact with other IoT subnetworks and/or other external subnetworks, important concerns relating to privacy, security, topology management, and efficiency may arise.

### SUMMARY

The following presents a simplified summary relating to one or more aspects and/or embodiments disclosed herein. As such, the following summary should not be considered an extensive overview relating to all contemplated aspects and/or embodiments, nor should the following summary be regarded to identify key or critical elements relating to all contemplated aspects and/or embodiments or to delineate the scope associated with any particular aspect and/or embodiment. Accordingly, the following summary has the sole purpose to present certain concepts relating to one or more aspects and/or embodiments relating to the mechanisms disclosed herein in a simplified form to precede the detailed description presented below.

According to various aspects, the present disclosure relates to various mechanisms to configure a dynamic ad hoc gateway that may be used in a mobile Internet of Things (IoT) network and/or other suitable IoT networks (or subnetworks) that may have dynamic or otherwise contextually dependent aspects, wherein the dynamic ad hoc gateway may be configured to provide inter-network communication among different IoT networks and/or IoT subnetworks. More particularly, in various embodiments, the dynamic ad hoc gateway may be assigned statically, hierarchically, dynamically, through a voting procedure, and/or any suitable combination thereof. For example, a static assignment scheme may assign a particular IoT device, if present, to be the dynamic ad hoc gateway, while a hierarchical assignment scheme may rank various IoT devices and assign the highest ranked IoT device to be the dynamic ad hoc gateway (e.g., a smart phone may be assigned a highest rank and a smart watch may be assigned a next highest rank, the IoT devices may be ranked according to how frequently each IoT device is assigned to be dynamic ad hoc gateway, etc.). Furthermore, in an assignment scheme that utilizes the voting procedure, various IoT devices in a particular IoT subnetwork may vote to elect one IoT device to be the dynamic ad hoc gateway, while a dynamic assignment scheme may be controlled at a home gateway, which may receive a request to assign the dynamic ad hoc gateway and relevant context information from the IoT subnetwork and dynamically assign the ad hoc gateway according to the relevant context information. Once the dynamic ad hoc gateway has been assigned, a trusted interface from the IoT subnetwork to one or more external IoT subnetworks may be provided via the dynamic ad hoc gateway, which may further provide functionality to selectively expose and/or selectively hide portions of a topology associated with the IoT subnetwork(s). Furthermore, to enforce security and privacy measures, the dynamic ad hoc gateway may require that all communications occur over the trusted interface and further limit the level of communication according to context (e.g., allowing different levels of communication between a personal IoT subnetwork and a trusted external network versus public and/or other untrusted external networks). Further still, the level of communication can be dynamically adopted depending on a user context (e.g., permitting certain communications in a car subnetwork when the owner is in the car versus when the owner is not in the car but there is a need to interact with a service center network).

According to various aspects, as mentioned above, the dynamic ad hoc gateway may be selected or otherwise assigned using static, hierarchical, dynamic, and/or voting-based mechanisms, each of which may employ one or more rules, heuristics, and other contextual information to select or otherwise assign the dynamic ad hoc gateway. For example, in various embodiments, the rules, heuristics, and/or other contextual information may be location-based (e.g., a smartphone may be designated as the gateway at the office, a car may be the gateway when on the road, a smartwatch may be the gateway while on a hike, etc.). In other examples, the rules, heuristics, and/or other contextual information may be based on certain services that IoT devices in a particular subnetwork need and/or certain services that are offered at visiting/visited IoT networks, based on supported interfaces (e.g., to match communication interfaces with communication interfaces used at visiting/visited IoT networks), and/or based on heuristics or trust (e.g., a particular IoT device frequently selected to be the gateway may be ranked higher and therefore more likely to be selected again in the future). Furthermore, the dynamic ad hoc gateway may aggregate communication within the proximal cloud associated with the IoT subnetwork to improve computational efficiency and support handoffs to another gateway node in response to topology changes (e.g., when one or more IoT devices leave and/or join the proximal cloud that defines the IoT subnetwork, when the context associated with the IoT subnetwork changes from communicating with a trusted home network to an untrusted public network, from an untrusted public network to a trusted public network, etc.).

According to various aspects, the dynamic ad hoc gateway may enable selective topology hiding and/or selective topology exposure in an IoT subnetwork based on trust relationships between various IoT nodes and networks, wherein the selective topology hiding and/or exposure may depend on services that hosting/visited IoT nodes advertise and that visiting/guest IoT gateway nodes discover. Accordingly, the dynamic ad hoc gateway may only make those IoT devices that are providing and/or utilizing advertised or required services visible outside the proximal IoT subnetwork, which may be determined according to predefined, dynamic, or user-approved rules that define trust handshakes between the dynamic ad hoc gateway and a gateway node associated with the overall IoT network.

According to various aspects, a method for providing a dynamic ad hoc IoT gateway according to the various aspects summarized above may comprise exchanging, at a first IoT device, connectivity and capability information with one or more other IoT devices, wherein the first IoT device and the one or more other IoT devices form an IoT subnetwork having a dynamic context, determining, at the first IoT device, that the first IoT device is assigned to be a gateway node on the IoT subnetwork based at least in part on the exchanged connectivity and capability information and the dynamic context associated with the IoT subnetwork, and establishing, at the first IoT device, a secure private network coupling the one or more other IoT devices to the assigned gateway node and an external interface from the secure private network for the one or more other IoT devices.

According to various aspects, an IoT device implementing one or more of the various aspects summarized above may comprise a transceiver configured to exchange connectivity and capability information with one or more other IoT devices, wherein the IoT device and the one or more other IoT devices form an IoT subnetwork having a dynamic context and one or more processors configured to determine that the IoT device is assigned to be a gateway node on the IoT subnetwork based at least in part on the exchanged connectivity and capability information and the dynamic context associated with the IoT subnetwork and establish a secure private network coupling the one or more other IoT devices to the assigned gateway node and an external interface from the secure private network for the one or more other IoT devices.

According to various aspects, an apparatus implementing one or more of the various aspects summarized above may comprise means for exchanging connectivity and capability information with one or more Internet of Things (IoT) devices, wherein the apparatus and the one or more IoT devices form an IoT subnetwork having a dynamic context, means for determining that the apparatus is assigned to be a gateway node on the IoT subnetwork based at least in part on the exchanged connectivity and capability information and the dynamic context associated with the IoT subnetwork, and means for establishing a secure private network coupling the one or more IoT devices to the assigned gateway node and an external interface from the secure private network for the one or more IoT devices.

According to various aspects, a computer-readable storage medium implementing one or more of the various aspects summarized above may have computer-executable instructions recorded thereon, wherein executing the computer-executable instructions on an IoT device may cause the IoT device to exchange connectivity and capability information with one or more other IoT devices, wherein the IoT device and the one or more other IoT devices form an IoT subnetwork having a dynamic context, determine that the IoT device is assigned to be a gateway node on the IoT subnetwork based at least in part on the exchanged connectivity and capability information and the dynamic context associated with the IoT subnetwork, and establish a secure private network coupling the one or more other IoT devices to the assigned gateway node and an external interface from the secure private network for the one or more other IoT devices.

Other objects and advantages associated with the aspects and embodiments disclosed herein will be apparent to those skilled in the art based on the accompanying drawings and detailed description.

### BRIEF DESCRIPTION OF THE DRAWINGS

A more complete appreciation of the various aspects and embodiments described herein and many attendant advantages thereof will be readily obtained as the same becomes better understood by reference to the following detailed description when considered in connection with the accompanying drawings which are presented solely for illustration and not limitation, and in which:

FIGS. 1A-1E illustrate exemplary high-level system architectures of wireless communication systems that may include various Internet of Things (IoT) devices, according to various aspects.

FIG. 2A illustrates an exemplary IoT device and FIG. 2B illustrates an exemplary passive IoT device, according to various aspects.

FIG. 3 illustrates a communication device that includes various structural components configured to perform functionality, according to various aspects.

FIG. 4 illustrates an exemplary server, according to various aspects.

FIG. 5 illustrates a wireless communication network that may support discoverable device-to-device (D2D) (or peer-to-peer (P2P)) services that can enable direct D2D communication, according to various aspects.

FIG. 6 illustrates an exemplary environment in which discoverable D2D services may be used to establish a proximity-based distributed bus over which various devices may communicate using D2D technology, according to various aspects.

FIG. 7 illustrates an exemplary signaling flow in which discoverable D2D services may be used to establish a proximity-based distributed bus over which various devices may communicate using D2D technology, according to various aspects.

FIG. 8A illustrates an exemplary proximity-based distributed bus that may be formed between two host devices to support D2D communication between the host devices, while FIG. 8B illustrates an exemplary architecture in which one or more embedded devices may connect to a host device to connect to a proximity-based distributed bus segment on the host device, according to various aspects.

FIGS. 9A-9C illustrate exemplary contexts in which a dynamic ad hoc gateway may provide inter-network communication among different IoT networks and/or IoT subnetworks, according to various aspects.

FIG. 10 illustrates an exemplary call flow to elect a dynamic ad hoc gateway in an IoT subnetwork, according to various aspects.

FIG. 11 illustrates an exemplary call flow that may be used to register with a dynamic ad hoc gateway in an IoT subnetwork, according to various aspects.

FIG. 12 illustrates an exemplary call flow in which dynamic ad hoc gateways in different IoT subnetworks may facilitate inter-network communication between the different IoT subnetworks, according to various aspects.

FIG. 13 illustrates an exemplary call flow in which a dynamic ad hoc gateway in one IoT subnetwork may act as a functional proxy to facilitate inter-network communication with another IoT subnetwork, according to various aspects.

FIG. 14 illustrates an exemplary communication device that may support direct D2D communication with other proximal devices, according to various aspects.

### DETAILED DESCRIPTION

Various aspects and embodiments are disclosed in the following description and related drawings to show specific examples relating to exemplary aspects and embodiments. Alternate aspects and embodiments will be apparent to those skilled in the pertinent art upon reading this disclosure, and may be constructed and practiced without departing from the scope or spirit of the disclosure. Additionally, well-known elements will not be described in detail or may be omitted so as to not obscure the relevant details of the aspects and embodiments disclosed herein.

The word “exemplary” is used herein to mean “serving as an example, instance, or illustration.” Any embodiment described herein as “exemplary” is not necessarily to be construed as preferred or advantageous over other embodiments. Likewise, the term “embodiments” does not require that all embodiments include the discussed feature, advantage or mode of operation.

The terminology used herein describes particular embodiments only and should not be construed to limit any embodiments disclosed herein. As used herein, the singular forms “a,” “an,” and “the” are intended to include the plural forms as well, unless the context clearly indicates otherwise. Those skilled in the art will further understand that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Further, many aspects are described in terms of sequences of actions to be performed by, for example, elements of a computing device. Those skilled in the art will recognize that various actions described herein can be performed by specific circuits (e.g., an application specific integrated circuit (ASIC)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects described herein may be embodied in a number of different forms, all of which have been contemplated to be within the scope of the claimed subject matter. In addition, for each of the aspects described herein, the corresponding form of any such aspects may be described herein as, for example, “logic configured to” perform the described action.

As used herein, the term “Internet of Things device” (or “IoT device”) may refer to any object (e.g., an appliance, a sensor, etc.) that has an addressable interface (e.g., an Internet protocol (IP) address, a Bluetooth identifier (ID), a near-field communication (NFC) ID, etc.) and can transmit information to one or more other devices over a wired or wireless connection. An IoT device may have a passive communication interface, such as a quick response (QR) code, a radio-frequency identification (RFID) tag, an NFC tag, or the like, or an active communication interface, such as a modem, a transceiver, a transmitter-receiver, or the like. An IoT device can have a particular set of attributes (e.g., a device state or status, such as whether the IoT device is on or off, open or closed, idle or active, available for task execution or busy, and so on, a cooling or heating function, an environmental monitoring or recording function, a light-emitting function, a sound-emitting function, etc.) that can be embedded in and/or controlled/monitored by a central processing unit (CPU), microprocessor, ASIC, or the like, and configured for connection to an IoT network such as a local ad hoc network or the Internet. For example, IoT devices may include, but are not limited to, refrigerators, toasters, ovens, microwaves, freezers, dishwashers, dishes, hand tools, clothes washers, clothes dryers, furnaces, air conditioners, thermostats, televisions, light fixtures, vacuum cleaners, sprinklers, electricity meters, gas meters, etc., so long as the devices are equipped with an addressable communication interface for communicating with the IoT network. IoT devices may also include cell phones, desktop computers, laptop computers, tablet computers, personal digital assistants (PDAs), etc. Accordingly, the IoT network may be comprised of a combination of “legacy” Internet-accessible devices (e.g., laptop or desktop computers, cell phones, etc.) in addition to devices that do not typically have Internet-connectivity (e.g., dishwashers, etc.).

As used herein, the terms “IoT subnetwork” (or “ISN”), ad hoc IoT network, and/or variants thereof may refer to an ad hoc network formed from one or more IoT devices, potentially including an IoT gateway node, which are associated to the same Layer 2 network (e.g., at a protocol layer that transfers data between nodes on the same local area network (LAN) segment or adjacent network nodes in a wide area network (WAN)). Alternatively (or additionally), an “IoT subnetwork, “ISN,” ad hoc IoT network, and/or variants thereof may refer to an ad hoc network formed from one or more IoT devices that are part of the same network based on one or more group management features above Layer 3 (e.g., above a network layer that handles functions such as logical addressing and routing data across interconnected networks based on unique logical addresses such as IP addresses). Furthermore, in the various aspects and embodiments described herein, IoT devices (including any potential IoT gateway node) that form an IoT subnetwork, ISN, ad hoc IoT network, and/or variants thereof may be mobile (e.g., not tied to a particular location), dynamic (e.g., functionality may change in different locations, due to context, etc.), and/or any suitable combination thereof.

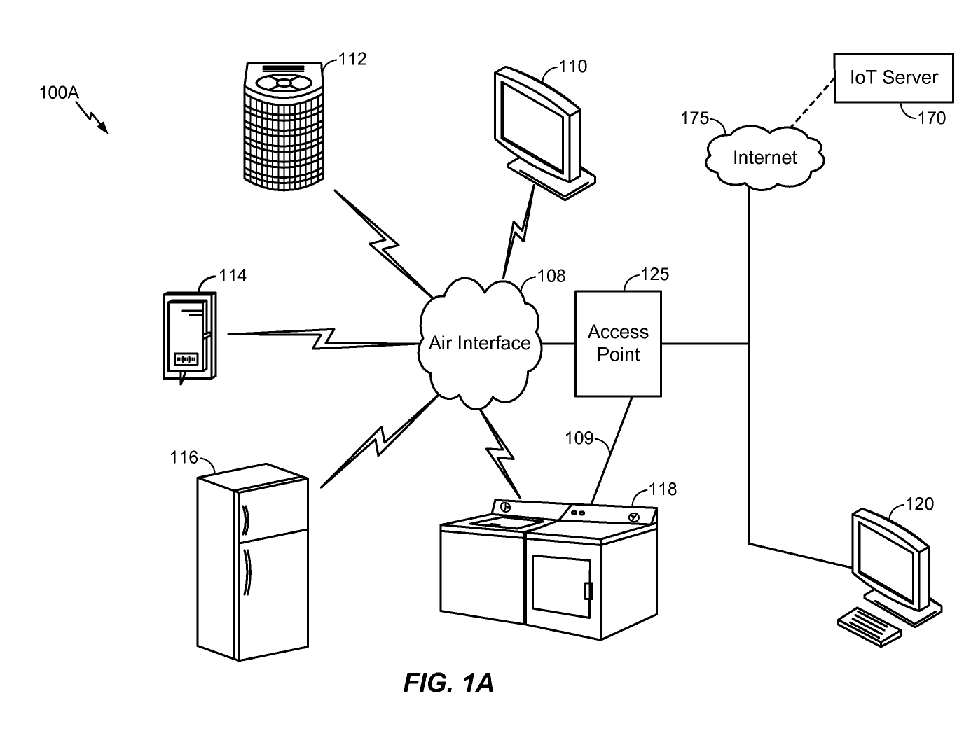

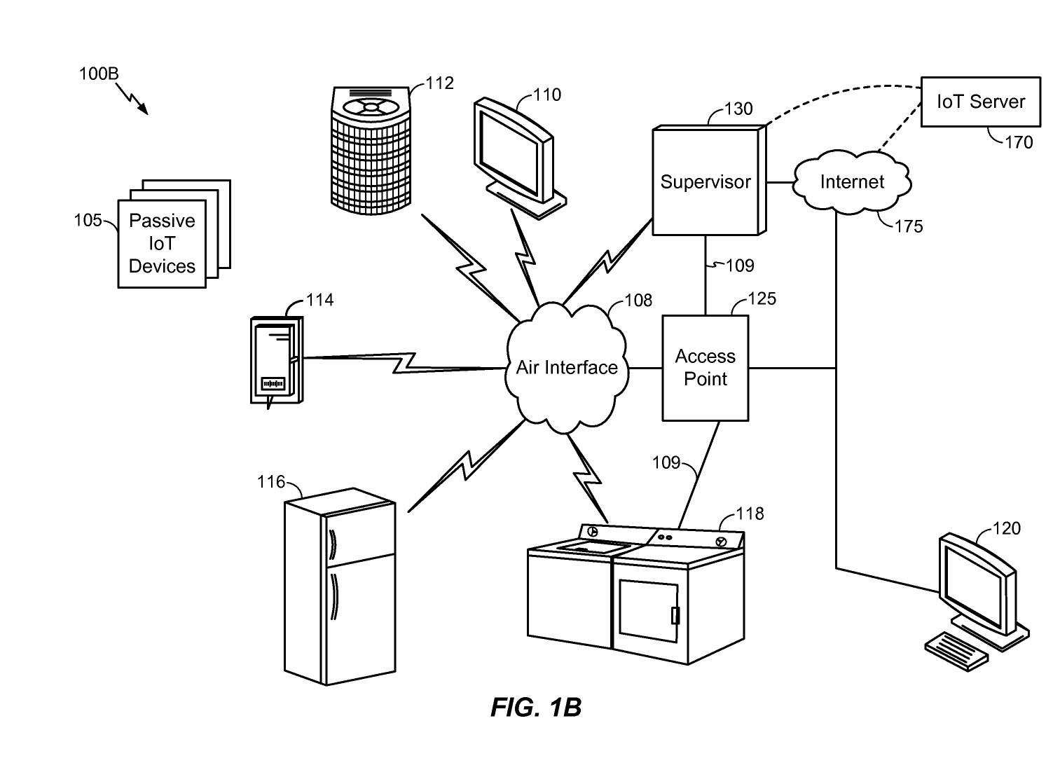

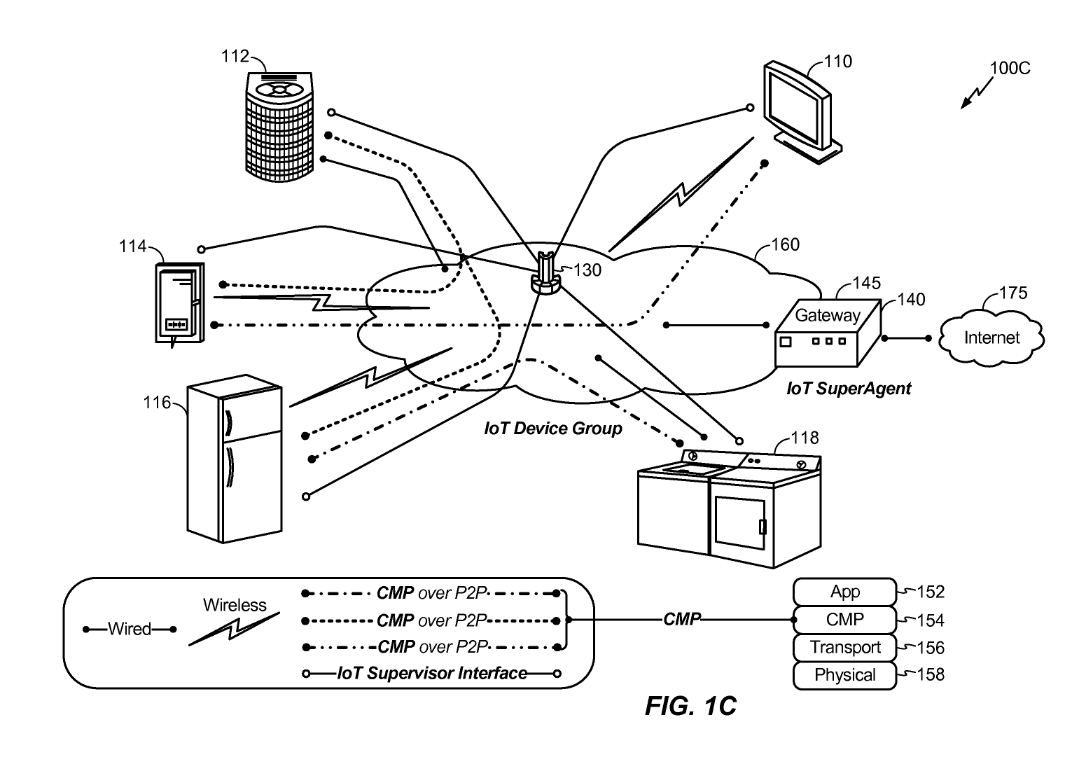

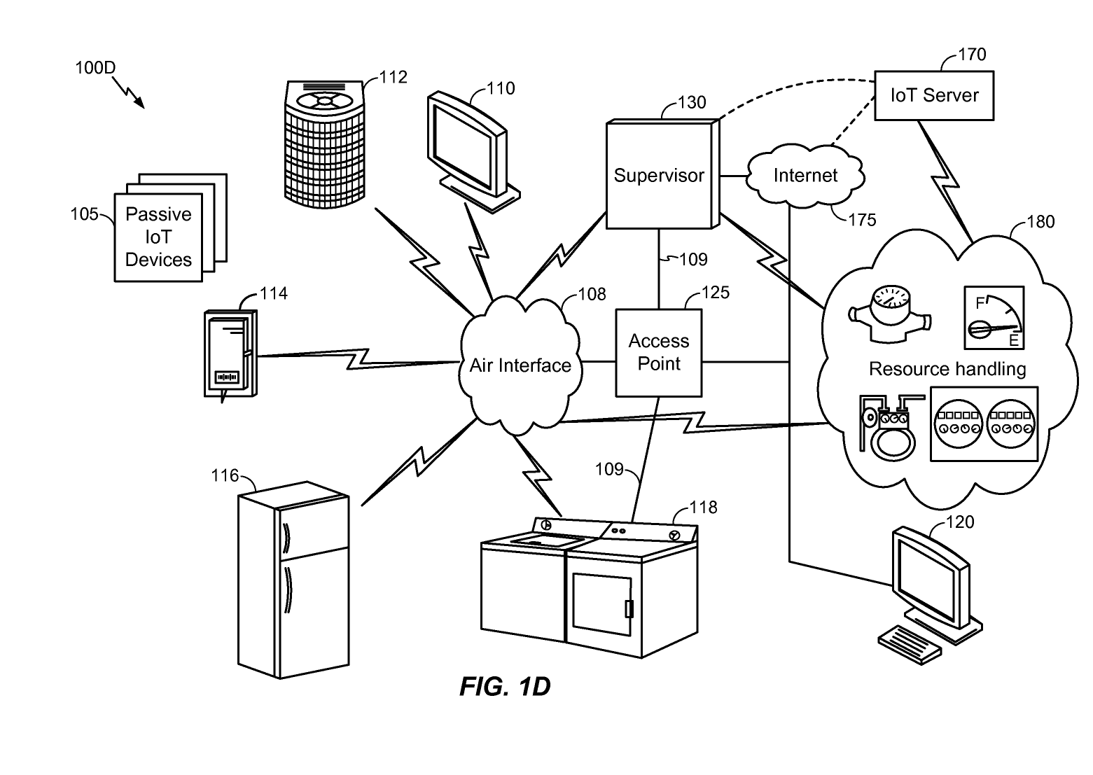

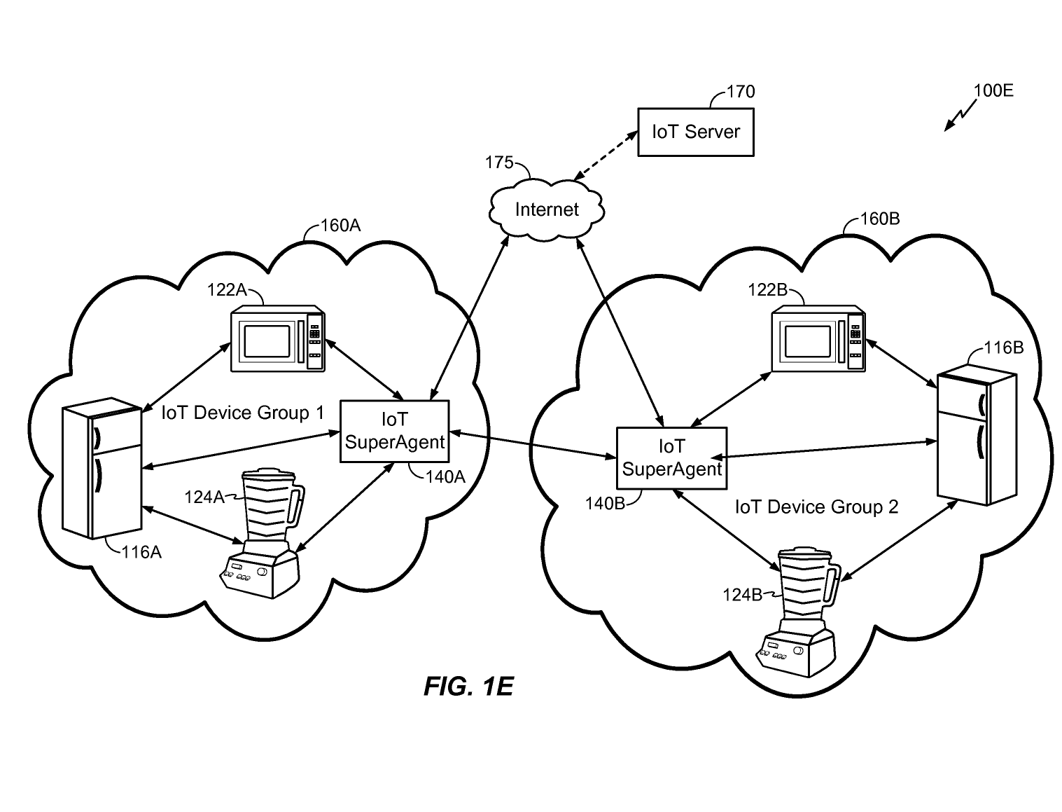

FIG. 1A illustrates a high-level system architecture of a wireless communication system 100A in accordance with various aspects. The wireless communication system 100A contains a plurality of IoT devices, which include a television IoT device 110, an outdoor air conditioning unit IoT device 112, a thermostat IoT device 114, a refrigerator IoT device 116, and a washer and dryer IoT device 118, which may be referred to hereinafter collectively as IoT devices 110-118.

Referring to FIG. 1A, the IoT devices 110-118 are configured to communicate with an access network (e.g., an access point 125) over a physical communication interface or layer, shown in FIG. 1A as an air interface 108 and a direct wired connection 109. The air interface 108 can comply with a wireless Internet protocol (IP), such as IEEE 802.11. Although FIG. 1A illustrates the IoT devices 110-118 communicating over the air interface 108 and washer and dryer IoT device 118 communicating over the direct wired connection 109, each of the IoT devices 110-118 may communicate over a wired connection, a wireless connection, or both.

The Internet 175 includes a number of routing agents and processing agents (not shown in FIG. 1A for the sake of convenience). The Internet 175 is a global system of interconnected computers and computer networks that uses a standard Internet protocol suite (e.g., the Transmission Control Protocol (TCP) and IP) to communicate among disparate devices/networks. TCP/IP provides end-to-end connectivity specifying how data should be formatted, addressed, transmitted, routed and received at the destination.

In FIG. 1A, a computer 120, such as a desktop or personal computer (PC), is shown as connecting to the Internet 175 directly (e.g., over an Ethernet connection or Wi-Fi or 802.11-based network). The computer 120 may have a wired connection to the Internet 175, such as a direct connection to a modem or router, which, in an example, can correspond to the access point 125 (e.g., for a Wi-Fi router with both wired and wireless connectivity). Alternatively, rather than being connected to the access point 125 and the Internet 175 over a wired connection, the computer 120 may be connected to the access point 125 over the air interface 108 or another wireless interface, and access the Internet 175 over the air interface 108. Although illustrated as a desktop computer, the computer 120 may be a laptop computer, a tablet computer, a PDA, a smart phone, or the like. The computer 120 may be an IoT device and/or contain functionality to manage an IoT network/group, such as the network/group of IoT devices 110-118.

The access point 125 may be connected to the Internet 175 via, for example, an optical communication system, such as FiOS, a cable modem, a digital subscriber line (DSL) modem, or the like. The access point 125 may communicate with IoT devices 110-120 and the Internet 175 using the standard Internet protocols (e.g., TCP/IP).

Referring to FIG. 1A, an IoT server 170 is shown as connected to the Internet 175. The IoT server 170 can be implemented as a plurality of structurally separate servers, or alternately may correspond to a single server. In various embodiments, the IoT server 170 may be optional (as indicated by the dotted line), and the group of IoT devices 110-120 may be a peer-to-peer (P2P) network. In such a case, the IoT devices 110-120 can communicate with each other directly over the air interface 108 and/or the direct wired connection 109 using appropriate device-to-device (D2D) communication technology. Alternatively, or additionally, some or all of the IoT devices 110-120 may be configured with a communication interface independent of the air interface 108 and the direct wired connection 109. For example, if the air interface 108 corresponds to a Wi-Fi interface, one or more of the IoT devices 110-120 may have Bluetooth or NFC interfaces for communicating directly with each other or communicating with one or more other Bluetooth or NFC-enabled devices.

In a peer-to-peer network, service discovery schemes can multicast the presence of nodes, their capabilities, and group membership. The peer-to-peer devices can establish associations and subsequent interactions based on this information.

In accordance with various aspects, FIG. 1B illustrates a high-level architecture of another wireless communication system 100B that contains a plurality of IoT devices. In general, the wireless communication system 100B shown in FIG. 1B may include various components that are the same and/or substantially similar to the wireless communication system 100A shown in FIG. 1A, which was described in greater detail above (e.g., various IoT devices, including a television 110, outdoor air conditioning unit 112, thermostat 114, refrigerator 116, and washer and dryer 118, that are configured to communicate with an access point 125 over an air interface 108 and/or a direct wired connection 109, a computer 120 that directly connects to the Internet 175 and/or connects to the Internet 175 through the access point 125, and an IoT server 170 accessible via the Internet 175, etc.). As such, for brevity and ease of description, various details relating to certain components in the wireless communication system 100B shown in FIG. 1B may be omitted herein to the extent that the same or similar details have already been provided above in relation to the wireless communication system 100A illustrated in FIG. 1A.

Referring to FIG. 1B, the wireless communication system 100B may include a supervisor device 130, which may alternatively be referred to as an IoT manager 130 or IoT manager device 130. As such, where the following description uses the term “supervisor device” 130, those skilled in the art will appreciate that any references to an IoT manager, group owner, or similar terminology may refer to the supervisor device 130 or another physical or logical component that provides the same or substantially similar functionality.

In various embodiments, the supervisor device 130 may generally observe, monitor, control, or otherwise manage the various other components in the wireless communication system 100B. For example, the supervisor device 130 can communicate with an access network (e.g., access point 125) over the air interface 108 and/or the direct wired connection 109 to monitor or manage attributes, activities, or other states associated with the various IoT devices 110-120 in the wireless communication system 100B. The supervisor device 130 may have a wired or wireless connection to the Internet 175 and optionally to the IoT server 170 (shown as a dotted line). The supervisor device 130 may obtain information from the Internet 175 and/or the IoT server 170 that can be used to further monitor or manage attributes, activities, or other states associated with the various IoT devices 110-120. The supervisor device 130 may be a standalone device or one of the IoT devices 110-120, such as the computer 120. The supervisor device 130 may be a physical device or a software application running on a physical device. The supervisor device 130 may include a user interface that can output information relating to the monitored attributes, activities, or other states associated with the IoT devices 110-120 and receive input information to control or otherwise manage the attributes, activities, or other states associated therewith. Accordingly, the supervisor device 130 may generally include various components and support various wired and wireless communication interfaces to observe, monitor, control, or otherwise manage the various components in the wireless communication system 100B.

The wireless communication system 100B shown in FIG. 1B may include one or more passive IoT devices 105 (in contrast to the active IoT devices 110-120) that can be coupled to or otherwise made part of the wireless communication system 100B. In general, the passive IoT devices 105 may include barcoded devices, Bluetooth devices, radio frequency (RF) devices, RFID tagged devices, infrared (IR) devices, NFC tagged devices, or any other suitable device that can provide an identifier and attributes associated therewith to another device when queried over a short range interface. Active IoT devices may detect, store, communicate, act on, and/or the like, changes in attributes of passive IoT devices.

For example, the one or more passive IoT devices 105 may include a coffee cup passive IoT device 105 and an orange juice container passive IoT device 105 (not expressly shown) that each have an RFID tag or barcode. A cabinet IoT device (not shown) and the refrigerator IoT device 118 may each have an appropriate scanner or reader that can read the RFID tag or barcode to detect when the coffee cup passive IoT device 105 and/or the orange juice container passive IoT device 105 have been added or removed. In response to the cabinet IoT device detecting the removal of the coffee cup passive IoT device 105 and the refrigerator IoT device 116 detecting the removal of the orange juice container passive IoT device 105, the supervisor device 130 may receive one or more signals that relate to the activities detected at the cabinet IoT device and the refrigerator IoT device 116. The supervisor device 130 may then infer that a user is drinking orange juice from the coffee cup passive IoT device 105 and/or likes to drink orange juice from the coffee cup passive IoT device 105.

Although the foregoing describes the passive IoT devices 105 as having some form of RFID tag or barcode communication interface, the passive IoT devices 105 may include one or more devices or other physical objects that do not have such communication capabilities. For example, certain IoT devices may have appropriate scanner or reader mechanisms that can detect shapes, sizes, colors, and/or other observable features associated with the passive IoT devices 105 to identify the passive IoT devices 105. In this manner, any suitable physical object may communicate an identity and one or more attributes associated therewith and become part of the wireless communication system 100B such that the supervisor device 130 may observe, monitor, control, or otherwise manage the physical object. Furthermore, in various embodiments, the passive IoT devices 105 may be coupled to or otherwise made part of the wireless communication system 100A in FIG. 1A and observed, monitored, controlled, or otherwise managed in a substantially similar manner.

In accordance with various aspects, FIG. 1C illustrates a high-level architecture of another wireless communication system 100C that contains a plurality of IoT devices. In general, the wireless communication system 100C shown in FIG. 1C may include various components that are the same and/or substantially similar to the wireless communication systems 100A and 100B shown in FIGS. 1A and 1B, respectively, which were described in greater detail above. As such, for brevity and ease of description, various details relating to certain components in the wireless communication system 100C shown in FIG. 1C may be omitted herein to the extent that the same or similar details have already been provided above in relation to the wireless communication systems 100A and 100B illustrated in FIGS. 1A and 1B, respectively.

The wireless communication system 100C shown in FIG. 1C illustrates exemplary peer-to-peer communication between the IoT devices 110-118 and the supervisor device 130. As shown in FIG. 1C, the supervisor device 130 communicates with each of the IoT devices 110-118 over an IoT supervisor interface. Further, IoT devices 110 and 114, IoT devices 112, 114, and 116, and IoT devices 116 and 118, communicate directly with each other.

The IoT devices 110-118 make up an IoT device group 160. The IoT device group 160 may comprise a group of locally connected IoT devices, such as the IoT devices connected to a user's home network. Although not shown, multiple IoT device groups may be connected to and/or communicate with each other via an IoT SuperAgent 140 connected to the Internet 175. At a high level, the supervisor device 130 manages intra-group communications, while the IoT SuperAgent 140 can manage inter-group communications. Although shown as separate devices, the supervisor device 130 and the IoT SuperAgent 140 may be, or reside on, the same device (e.g., a standalone device or an IoT device, such as the computer 120 in FIG. 1A and FIG. 1B). Alternatively, the IoT SuperAgent 140 may correspond to, or include, the functionality of the access point 125. As yet another alternative, the IoT SuperAgent 140 may correspond to, or include, the functionality of an IoT server, such as the IoT server 170. Furthermore, in various embodiments, the IoT SuperAgent 140 may also encapsulate gateway functionality 145.

According to various aspects, the IoT devices 110-118 can each treat the supervisor device 130 as a peer and transmit attribute/schema updates to the supervisor device 130. When an IoT device needs to communicate with another IoT device, the IoT device can request the pointer to that IoT device from the supervisor device 130 and then communicate with the target IoT device as a peer. The IoT devices 110-118 can communicate with each other over a peer-to-peer communication network using a common messaging protocol (CMP). As long as any two IoT devices (e.g., among the various IoT devices 110-118) are CMP-enabled and connected over a common communication transport, the two IoT devices can communicate with each other. In the protocol stack, a CMP layer 154 is below an application layer 152 and above a transport layer 156 that resides between the CMP layer 154 and a physical layer 158 associated with the protocol stack.

In accordance with various aspects, FIG. 1D illustrates a high-level architecture of another wireless communication system 100D that contains a plurality of IoT devices. In general, the wireless communication system 100D shown in FIG. 1D may include various components that are the same and/or substantially similar to the wireless communication systems 100A-100C shown in FIGS. 1A-1C, respectively, which were described in greater detail above. As such, for brevity and ease of description, various details relating to certain components in the wireless communication system 100D shown in FIG. 1D may be omitted herein to the extent that the same or similar details have already been provided above in relation to the wireless communication systems 100A-100C illustrated in FIGS. 1A-1C, respectively.

The Internet 175 is a “resource” that can be regulated using the concept of the IoT. However, the Internet 175 is just one example of a resource that is regulated, and any resource could be regulated using the concept of the IoT. Other resources that can be regulated include, but are not limited to, electricity, gas, storage, security, and the like. An IoT device may be connected to the resource and thereby regulate the resource, or the resource could be regulated over the Internet 175. FIG. 1D illustrates several resources 180, such as natural gas, gasoline, hot water, and electricity, wherein the resources 180 can be regulated in addition to and/or over the Internet 175.

IoT devices can communicate with each other to regulate their use of one or more of the resources 180 available in the wireless communication system 100D. For example, IoT devices such as a toaster, a computer, and a hairdryer (not shown) may communicate with each other over a Bluetooth communication interface to regulate usage of an electricity resource 180. Furthermore, in another example, IoT devices such as a desktop computer, a telephone, and a tablet computer (not shown) may communicate over a Wi-Fi communication interface to regulate access to the Internet 175, which may also be one of the resources 180 available in the wireless communication system 100D. As yet another example, IoT devices such as a stove, a clothes dryer, and a water heater (not shown) may communicate over a Wi-Fi communication interface to regulate usage of a gas resource 180. Alternatively, or additionally, each IoT device may be connected to an IoT server, such as the IoT server 170, which may comprise logic configured to regulate usage of one or more of the resources 180 based on information received from the IoT devices.

In accordance with various aspects, FIG. 1E illustrates a high-level architecture of another wireless communication system 100E that contains a plurality of IoT devices. In general, the wireless communication system 100E shown in FIG. 1E may include various components that are the same and/or substantially similar to the wireless communication systems 100A-100D shown in FIGS. 1A-1D, respectively, which were described in greater detail above. As such, for brevity and ease of description, various details relating to certain components in the wireless communication system 100E shown in FIG. 1E may be omitted herein to the extent that the same or similar details have already been provided above in relation to the wireless communication systems 100A-100D illustrated in FIGS. 1A-1D, respectively.

The wireless communication system 100E includes two IoT device groups 160A and 160B. Multiple IoT device groups may each be connected to and/or communicate with each other via a respective IoT SuperAgent connected to the Internet 175. At a high level, the IoT SuperAgent may manage inter-group communication among IoT device groups. For example, in FIG. 1E, the IoT device group 160A includes IoT devices 116A, 122A, and 124A and an IoT SuperAgent 140A, while the IoT device group 160B includes IoT devices 116B, 122B, and 124B and an IoT SuperAgent 140B. As such, the IoT SuperAgents 140A and 140B may connect to the Internet 175 and communicate with each other over the Internet 175 and/or communicate with each other directly to facilitate communication between the IoT device groups 160A and 160B. Furthermore, although FIG. 1E illustrates two IoT device groups 160A and 160B communicating with each other via the IoT SuperAgents 140A and 140B, those skilled in the art will appreciate that any number of IoT device groups may suitably communicate with each other using IoT SuperAgents.

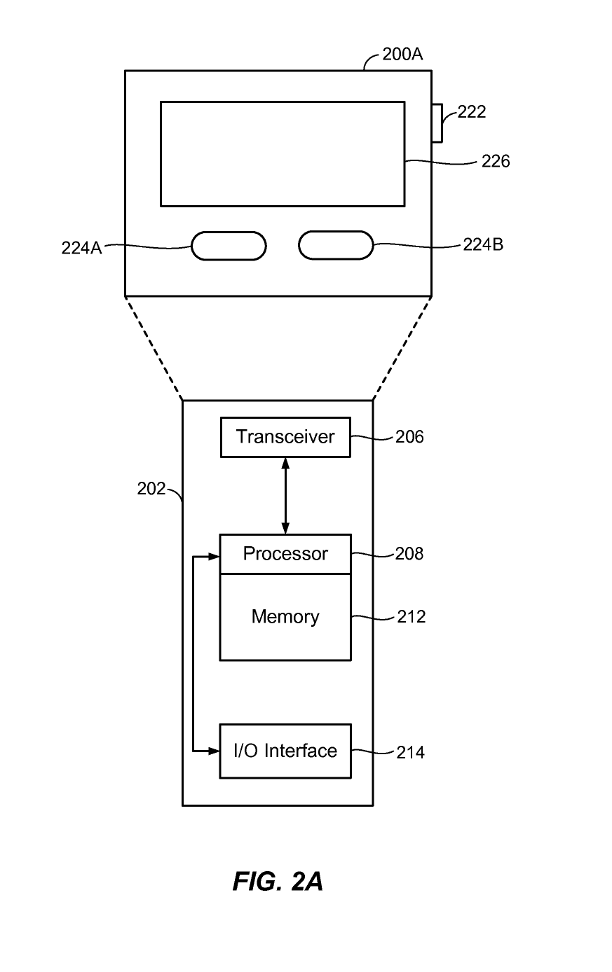

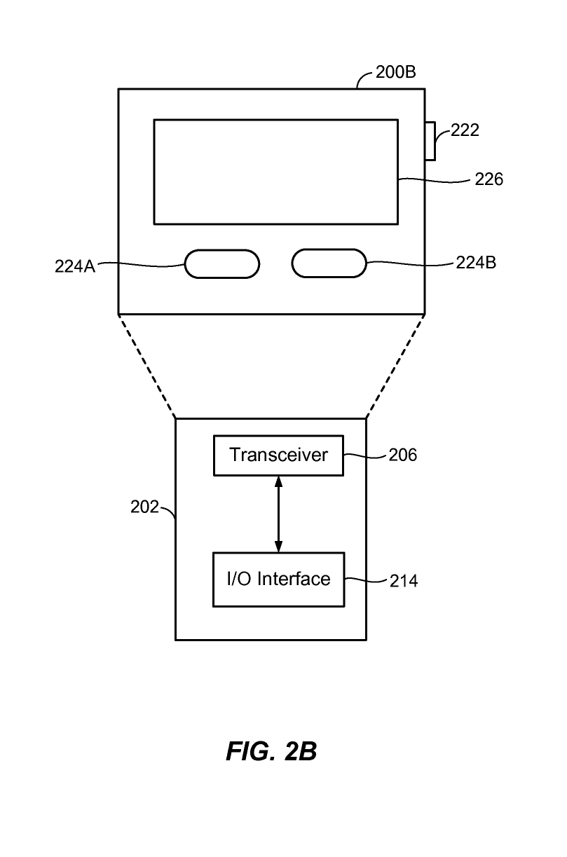

FIG. 2A illustrates a high-level example of an IoT device 200A in accordance with various aspects. While external appearances and/or internal components can differ significantly among IoT devices, most IoT devices will have some sort of user interface, which may comprise a display and a means for user input. IoT devices without a user interface can be communicated with remotely over a wired or wireless network, such as the air interface 108 in FIG. 1A and FIG. 1B.

As shown in FIG. 2A, in an example configuration for the IoT device 200A, an external casing of the IoT device 200A may be configured with a display 226, a power button 222, and two control buttons 224A and 224B, among other components, as is known in the art. The display 226 may be a touchscreen display, in which case the control buttons 224A and 224B may not be necessary. While not shown explicitly as part of the IoT device 200A, the IoT device 200A may include one or more external antennas and/or one or more integrated antennas that are built into the external casing, including but not limited to Wi-Fi antennas, cellular antennas, satellite position system (SPS) antennas (e.g., global positioning system (GPS) antennas), and so on.

While internal components of IoT devices, such as the IoT device 200A, can be embodied with different hardware configurations, a basic high-level configuration for internal hardware components is shown as platform 202 in FIG. 2A. The platform 202 can receive and execute software applications, data and/or commands transmitted over a network interface, such as the air interface 108 in FIG. 1A and FIG. 1B and/or a wired interface. The platform 202 can also independently execute locally stored applications. The platform 202 can include one or more transceivers 206 configured for wired and/or wireless communication (e.g., a Wi-Fi transceiver, a Bluetooth transceiver, a cellular transceiver, a satellite transceiver, a GPS or SPS receiver, etc.) operably coupled to one or more processors 208, such as a microcontroller, microprocessor, application specific integrated circuit, digital signal processor (DSP), programmable logic circuit, or other data processing device, which will be generally referred to as the processor 208. The processor 208 can execute application programming instructions within a memory 212 of the IoT device 200A. The memory 212 can include one or more of read-only memory (ROM), random-access memory (RAM), electrically erasable programmable ROM (EEPROM), flash cards, or any memory common to computer platforms. One or more input/output (I/O) interfaces 214 can be configured to allow the processor 208 to communicate with and control various I/O devices such as the display 226, power button 222, control buttons 224A and 224B as illustrated, and any other devices, such as sensors, actuators, relays, valves, switches, etc. associated with the IoT device 200A.

Accordingly, various aspects can include an IoT device (e.g., IoT device 200A) including the ability to perform the functions described herein. As will be appreciated by those skilled in the art, the various logic elements can be embodied in discrete elements, software modules executed on a processor (e.g., the processor 208) or any combination of software and hardware to achieve the functionality disclosed herein. For example, the transceiver 206, the processor 208, the memory 212, and the I/O interface 214 may all be used cooperatively to load, store and execute the various functions disclosed herein and thus the logic to perform these functions may be distributed over various elements. Alternatively, the functionality could be incorporated into one discrete component. Therefore, the features of the IoT device 200A in FIG. 2A are to be considered merely illustrative and the IoT device 200A is not limited to the illustrated features or arrangement shown in FIG. 2A.

FIG. 2B illustrates a high-level example of a passive IoT device 200B in accordance with various aspects. In general, the passive IoT device 200B shown in FIG. 2B may include various components that are the same and/or substantially similar to the IoT device 200A shown in FIG. 2A, which was described in greater detail above. As such, for brevity and ease of description, various details relating to certain components in the passive IoT device 200B shown in FIG. 2B may be omitted herein to the extent that the same or similar details have already been provided above in relation to the IoT device 200A illustrated in FIG. 2A.

The passive IoT device 200B shown in FIG. 2B may generally differ from the IoT device 200A shown in FIG. 2A in that the passive IoT device 200B may not have a processor, internal memory, or certain other components. Instead, in various embodiments, the passive IoT device 200B may only include an I/O interface 214 or other suitable mechanism that allows the passive IoT device 200B to be observed, monitored, controlled, managed, or otherwise known within a controlled IoT network. For example, in various embodiments, the I/O interface 214 associated with the passive IoT device 200B may include a barcode, Bluetooth interface, radio frequency (RF) interface, RFID tag, IR interface, NFC interface, or any other suitable I/O interface that can provide an identifier and attributes associated with the passive IoT device 200B to another device when queried over a short range interface (e.g., an active IoT device, such as IoT device 200A, that can detect, store, communicate, act on, or otherwise process information relating to the attributes associated with the passive IoT device 200B).

Although the foregoing describes the passive IoT device 200B as having some form of RF, barcode, or other I/O interface 214, the passive IoT device 200B may comprise a device or other physical object that does not have such an I/O interface 214. For example, certain IoT devices may have appropriate scanner or reader mechanisms that can detect shapes, sizes, colors, and/or other observable features associated with the passive IoT device 200B to identify the passive IoT device 200B. In this manner, any suitable physical object may communicate an identity and one or more attributes associated therewith and be observed, monitored, controlled, or otherwise managed within a controlled IoT network.

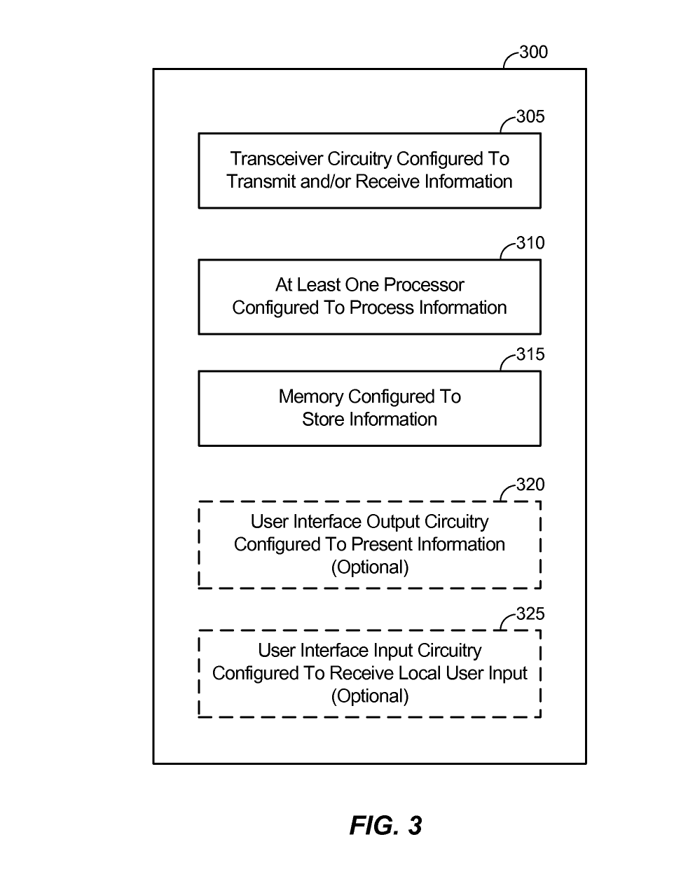

FIG. 3 illustrates a communication device 300 that includes various structural components configured to perform functionality. The communication device 300 can correspond to any of the communication devices described in further detail above, including but not limited to any one or more of the IoT devices or other devices in the wireless communication systems 100A-100E shown in FIGS. 1A-1E, the IoT device 200A shown in FIG. 2A, the passive IoT device 200B shown in FIG. 2B, any components coupled to the Internet 175 (e.g., the IoT server 170), and so on. Accordingly, those skilled in the art will appreciate that the communication device 300 shown in FIG. 3 can correspond to any electronic device configured to communicate with and/or facilitate communication with one or more other entities, such as in the wireless communication systems 100A-100E as shown in FIGS. 1A-1E.

Referring to FIG. 3, the communication device 300 includes transceiver circuitry configured to transmit and/or receive information 305. In an example, if the communication device 300 corresponds to a wireless communication device (e.g., IoT device 200A and/or passive IoT device 200B), the transceiver circuitry configured to transmit and/or receive information 305 can include a wireless communication interface (e.g., Bluetooth, Wi-Fi, Wi-Fi Direct, Long-Term Evolution (LTE) Direct, etc.) such as a wireless transceiver and associated hardware (e.g., an RF antenna, a MODEM, a modulator and/or demodulator, etc.). In another example, the transceiver circuitry configured to transmit and/or receive information 305 can correspond to a wired communication interface (e.g., a serial connection, a USB or Firewire connection, an Ethernet connection through which the Internet 175 can be accessed, etc.). Thus, if the communication device 300 corresponds to some type of network-based server (e.g., the IoT server 170), the transceiver circuitry configured to transmit and/or receive information 305 can correspond to an Ethernet card, in an example, that connects the network-based server to other communication entities via an Ethernet protocol. In a further example, the transceiver circuitry configured to transmit and/or receive information 305 can include sensory or measurement hardware by which the communication device 300 can monitor a local environment associated therewith (e.g., an accelerometer, a temperature sensor, a light sensor, an antenna for monitoring local RF signals, etc.). The transceiver circuitry configured to transmit and/or receive information 305 can also include software that, when executed, permits the associated hardware of the transceiver circuitry configured to transmit and/or receive information 305 to perform the reception and/or transmission function(s) associated therewith. However, the transceiver circuitry configured to transmit and/or receive information 305 does not correspond to software alone, and the transceiver circuitry configured to transmit and/or receive information 305 relies at least in part upon structural hardware to achieve the functionality associated therewith.

Referring to FIG. 3, the communication device 300 further includes at least one processor configured to process information 310. Example implementations of the type of processing that can be performed by the at least one processor configured to process information 310 includes but is not limited to performing determinations, establishing connections, making selections between different information options, performing evaluations related to data, interacting with sensors coupled to the communication device 300 to perform measurement operations, converting information from one format to another (e.g., between different protocols such as .wmv to .avi, etc.), and so on. For example, the at least one processor configured to process information 310 can include a general purpose processor, a DSP, an ASIC, a field programmable gate array (FPGA) or other programmable logic device, discrete gate or transistor logic, discrete hardware components, or any combination thereof designed to perform the functions described herein. A general purpose processor may be a microprocessor, but in the alternative, the at least one processor configured to process information 310 may be any conventional processor, controller, microcontroller, or state machine. The at least one processor configured to process information 310 may also be implemented as a combination of computing devices (e.g., a combination of a DSP and a microprocessor, a plurality of microprocessors, one or more microprocessors in conjunction with a DSP core, or any other such configuration). The at least one processor configured to process information 310 can also include software that, when executed, permits the associated hardware of the at least one processor configured to process information 310 to perform the processing function(s) associated therewith. However, the at least one processor configured to process information 310 does not correspond to software alone, and the at least one processor configured to process information 310 relies at least in part upon structural hardware to achieve the functionality associated therewith.

Referring to FIG. 3, the communication device 300 further includes memory configured to store information 315. In an example, the memory configured to store information 315 can include at least a non-transitory memory and associated hardware (e.g., a memory controller, etc.). For example, the non-transitory memory included in the memory configured to store information 315 can correspond to RAM, flash memory, ROM, erasable programmable ROM (EPROM), EEPROM, registers, hard disk, a removable disk, a CD-ROM, or any other form of storage medium known in the art. The memory configured to store information 315 can also include software that, when executed, permits the associated hardware of the memory configured to store information 315 to perform the storage function(s) associated therewith. However, the memory configured to store information 315 does not correspond to software alone, and the memory configured to store information 315 relies at least in part upon structural hardware to achieve the functionality associated therewith.

Referring to FIG. 3, the communication device 300 further optionally includes user interface output circuitry configured to present information 320. In an example, the user interface output circuitry configured to present information 320 can include at least an output device and associated hardware. For example, the output device can include a video output device (e.g., a display screen, a port that can carry video information such as USB, HDMI, etc.), an audio output device (e.g., speakers, a port that can carry audio information such as a microphone jack, USB, HDMI, etc.), a vibration device and/or any other device by which information can be formatted for output or actually outputted by a user or operator of the communication device 300. For example, if the communication device 300 corresponds to the IoT device 200A as shown in FIG. 2A and/or the passive IoT device 200B as shown in FIG. 2B, the user interface output circuitry configured to present information 320 can include the display 226. In a further example, the user interface output circuitry configured to present information 320 can be omitted for certain communication devices, such as network communication devices that do not have a local user (e.g., network switches or routers, remote servers, etc.). The user interface output circuitry configured to present information 320 can also include software that, when executed, permits the associated hardware of the user interface output circuitry configured to present information 320 to perform the presentation function(s) associated therewith. However, the user interface output circuitry configured to present information 320 does not correspond to software alone, and the user interface output circuitry configured to present information 320 relies at least in part upon structural hardware to achieve the functionality associated therewith.

Referring to FIG. 3, the communication device 300 further optionally includes user interface input circuitry configured to receive local user input 325. In an example, the user interface input circuitry configured to receive local user input 325 can include at least a user input device and associated hardware. For example, the user input device can include buttons, a touchscreen display, a keyboard, a camera, an audio input device (e.g., a microphone or a port that can carry audio information such as a microphone jack, etc.), and/or any other device by which information can be received from a user or operator of the communication device 300. For example, if the communication device 300 corresponds to the IoT device 200A as shown in FIG. 2A and/or the passive IoT device 200B as shown in FIG. 2B, the user interface input circuitry configured to receive local user input 325 can include the buttons 222, 224A, and 224B, the display 226 (if a touchscreen), etc. In a further example, the user interface input circuitry configured to receive local user input 325 can be omitted for certain communication devices, such as network communication devices that do not have a local user (e.g., network switches or routers, remote servers, etc.). The user interface input circuitry configured to receive local user input 325 can also include software that, when executed, permits the associated hardware of the user interface input circuitry configured to receive local user input 325 to perform the input reception function(s) associated therewith. However, the user interface input circuitry configured to receive local user input 325 does not correspond to software alone, and the user interface input circuitry configured to receive local user input 325 relies at least in part upon structural hardware to achieve the functionality associated therewith.

Referring to FIG. 3, while the structural components 305 through 325 are shown as separate or distinct blocks in FIG. 3, those skilled in the art will appreciate that the various structural components 305 through 325 may be coupled to one other via an associated communication bus (not shown) and further that the hardware and/or software through which the respective structural components 305 through 325 perform the respective functionality associated therewith can overlap in part. For example, any software used to facilitate the functionality associated with the structural components 305 through 325 can be stored in the non-transitory memory associated with the memory configured to store information 315, such that the configured structural components 305 through 325 each perform the respective functionality associated therewith (i.e., in this case, software execution) based in part upon the operation of the software stored in the memory configured to store information 315. Likewise, hardware that is directly associated with one of the structural components 305 through 325 can be borrowed or used by other structural components 305 through 325 from time to time. For example, the at least one processor configured to process information 310 can format data into an appropriate format before being transmitted via the transceiver circuitry configured to transmit and/or receive information 305, such that the transceiver circuitry configured to transmit and/or receive information 305 performs the functionality associated therewith (i.e., in this case, transmission of data) based in part upon the operation of structural hardware associated with the at least one processor configured to process information 310.

Accordingly, those skilled in the art will appreciate that the various structural components 305 through 325 as shown in FIG. 3 are intended to invoke an aspect that is at least partially implemented with structural hardware, and are not intended to map to software-only implementations that are independent of hardware and/or non-structural (e.g., purely functional) interpretations. Furthermore, those skilled in the art will appreciate other interactions or cooperation between the structural components 305 through 325, which will become clear based on the various aspects and embodiments described more fully below.

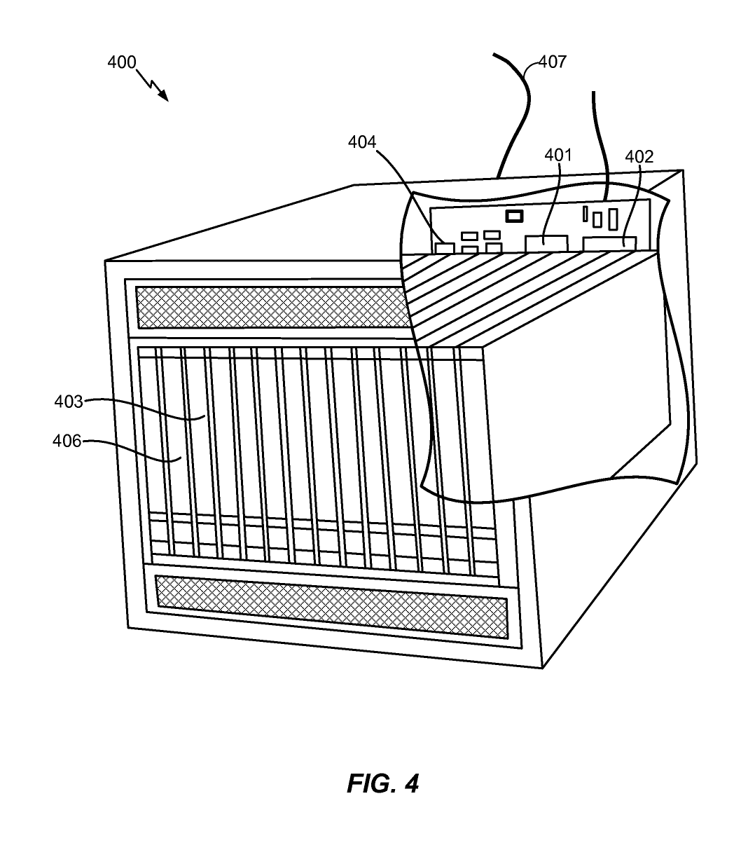

The various aspects and embodiments described herein may be implemented on any of a variety of commercially available server devices, including a server 400 as illustrated in FIG. 4. In an example, the server 400 may correspond to one example configuration of the IoT server 170 described above. In FIG. 4, the server 400 includes a processor 401 coupled to a volatile memory 402 and a nonvolatile memory 403 (e.g., a large capacity hard disk). The server 400 may also include a floppy disk drive, a compact disk (CD) drive, and/or a DVD disk drive 406 coupled to the processor 401. The server 400 may also include network access ports 404 coupled to the processor 401 for establishing data connections with a network 407, such as a local area network coupled to other broadcast system computers and servers or to the Internet. In context with FIG. 3, those skilled in the art will appreciate that the server 400 of FIG. 4 illustrates one example implementation of the communication device 300, whereby the transceiver circuitry configured to transmit and/or receive information 305 may correspond to the network access ports 404 used by the server 400 to communicate with the network 407, the at least one processor configured to process information 310 may correspond to the processor 401, and the memory configured to store information 315 may correspond to any combination of the volatile memory 402, the nonvolatile memory 403, and/or the floppy/CD/DVD disk drive 406. The optional user interface output circuitry configured to present information 320 and the optional user interface input circuitry configured to receive local user input 325 are not shown explicitly in FIG. 4 and may or may not be included therein. Thus, FIG. 4 helps to demonstrate that the communication device 300 may be implemented as a server, in addition to an IoT device implementation as in FIG. 2A.

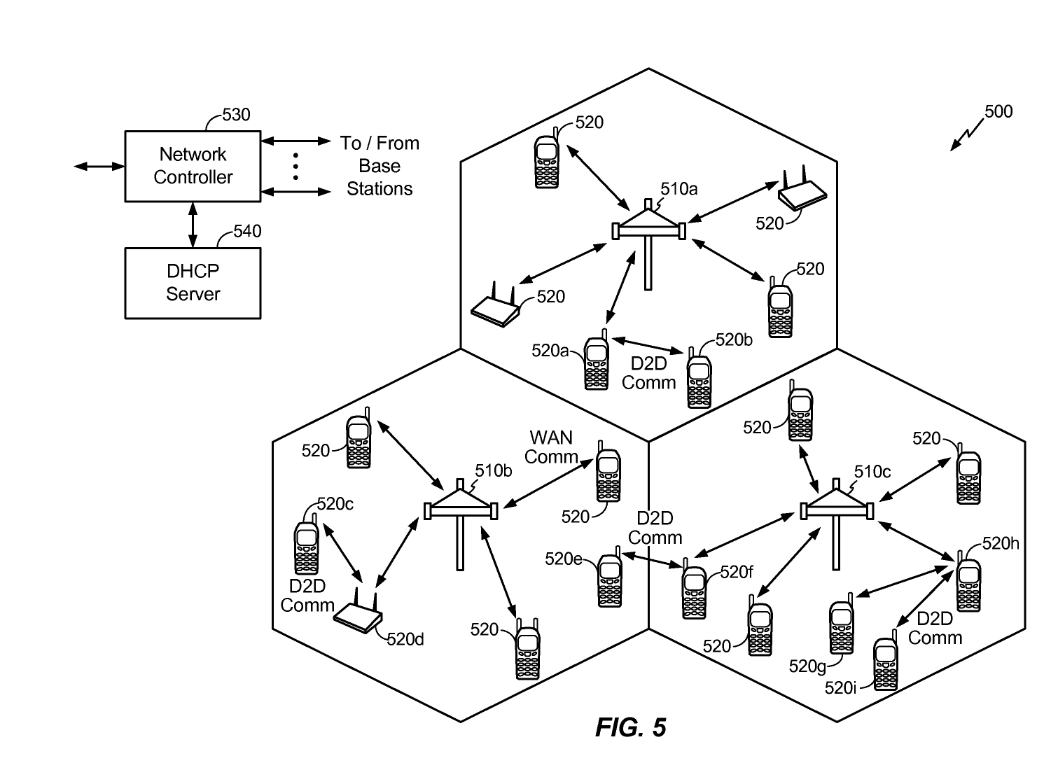

In general, as noted above, IP based technologies and services have become more mature, driving down the cost and increasing availability of IP, which has allowed Internet connectivity to be added to more and more types of everyday electronic objects. As such, the IoT is based on the idea that everyday electronic objects, not just computers and computer networks, can be readable, recognizable, locatable, addressable, and controllable via the Internet. In general, with the development and increasing prevalence of the IoT, numerous proximate heterogeneous IoT devices and other physical objects that have different types and perform different activities (e.g., lights, printers, refrigerators, air conditioners, etc.) may interact with one another in many different ways and be used in many different ways. As such, due to the potentially large number of heterogeneous IoT devices and other physical objects that may be in use within a controlled IoT network, well-defined and reliable communication interfaces are generally needed to connect the various heterogeneous IoT devices such that the various heterogeneous IoT devices can be appropriately configured, managed, and communicate with one another to exchange information, among other things. Accordingly, the following description provided in relation to FIGS. 5-8 generally outlines an exemplary communication framework that may support discoverable device-to-device (D2D) or peer-to-peer (P2P) services that can enable direct D2D communication among heterogeneous devices in a distributed programming environment as disclosed herein.

In general, user equipment (UE) (e.g., telephones, tablet computers, laptop and desktop computers, vehicles, etc.), can be configured to connect with one another locally (e.g., Bluetooth, local Wi-Fi, etc.), remotely (e.g., via cellular networks, through the Internet, etc.), or according to suitable combinations thereof. Furthermore, certain UEs may also support proximity-based D2D communication using certain wireless networking technologies (e.g., Wi-Fi, Bluetooth, Wi-Fi Direct, etc.) that support one-to-one connections or simultaneous connections to a group that includes several devices directly communicating with one another. To that end, FIG. 5 illustrates an exemplary wireless communication network or WAN 500 that may support discoverable D2D services that can enable direct D2D communication, wherein the WAN 500 may comprise an LTE network or another suitable WAN that includes various base stations 510a-510c and other network entities, wherein the various base stations 510a-510c may be collectively referred to herein as base stations 510. For simplicity, only three base stations 510a, 510b and 510c, one network controller 530, and one Dynamic Host Configuration Protocol (DHCP) server 540 are shown in FIG. 5. Each of the base stations 510 may be an entity that communicates with one or more devices 520 and may also be referred to as a Node B, an evolved Node B (eNB), an access point, etc. Each base station 510 may provide communication coverage for a particular geographic area and may support communication for the devices 520 located within the coverage area. To improve network capacity, the overall coverage area of a base station 510 may be partitioned into multiple (e.g., three) smaller areas, wherein each smaller area may be served by a respective base station 510. In 3GPP, the term “cell” can refer to a coverage area of a base station 510 and/or a base station subsystem 510 serving this coverage area, depending on the context in which the term is used. In 3GPP2, the term “sector” or “cell-sector” can refer to a coverage area of a base station 510 and/or a base station subsystem 510 serving this coverage area. For clarity, the 3GPP concept of “cell” may be used in the description herein.

A base station 510 may provide communication coverage for a macro cell, a pico cell, a femto cell, and/or other cell types. A macro cell may cover a relatively large geographic area (e.g., several kilometers in radius) and may allow unrestricted access by devices 520 with service subscription. A pico cell may cover a relatively small geographic area and may allow unrestricted access by devices 520 with service subscription. A femto cell may cover a relatively small geographic area (e.g., a home) and may allow restricted access by devices 520 having association with the femto cell (e.g., devices 520 in a Closed Subscriber Group (CSG)). In the example shown in FIG. 5, the WAN 500 includes macro base stations 510a, 510b and 510c for macro cells. The WAN 500 may also include pico base stations 510 for pico cells and/or home base stations 510 for femto cells (not shown in FIG. 5).

The network controller 530 may couple to a set of base stations 510 and may provide coordination and control for these base stations 510. The network controller 530 may be a single network entity or a collection of network entities that can communicate with the base stations 510 via a backhaul. The base stations 510 may also communicate with one another (e.g., directly or indirectly via wireless or wireline backhaul). The DHCP server 540 may support D2D communication, as described below. The DHCP server 540 may be part of the WAN 500, external to the WAN 500, run via Internet Connection Sharing (ICS), or any suitable combination thereof. Furthermore, in various embodiments, the DHCP server 540 may be a separate entity (e.g., as shown in FIG. 5) or may be part of the base stations 510, network controller 530, or some other entity. In any case, the DHCP server 540 may be reachable by one or more devices 520 desiring to communicate with one another directly.

The devices 520 may be dispersed throughout the WAN 500, and each device 520 may be stationary or mobile. A device 520 may also be referred to as a node, user equipment (UE), a station, a mobile station, a terminal, an access terminal, a subscriber unit, etc. Furthermore, any one or more of the devices 520 may be a cellular phone, a personal digital assistant (PDA), a wireless modem, a wireless communication device, a handheld device, a laptop computer, a cordless phone, a wireless local loop (WLL) station, a smart phone, a netbook, a smartbook, a tablet, etc. The devices 520 may communicate with the respective base stations 510 in the WAN 500 and may further communicate peer-to-peer with other devices 520. For example, as shown in FIG. 5, devices 520a and 520b may communicate peer-to-peer, devices 520c and 520d may communicate peer-to-peer, devices 520e and 520f may communicate peer-to-peer, and devices 520g, 520h, and 520i may communicate peer-to-peer, while remaining devices 520 may communicate with the base stations 510. As further shown in FIG. 5, the devices 520a, 520d, 520f, and 520h may also communicate with respective base stations 510a-510c (e.g., when not engaged in D2D communication, or possibly concurrent with D2D communication).

In the description herein, WAN communication may refer to communication between a device 520 and a base station 510 in the WAN 500 (e.g., for a call with a remote entity such as another device 520). A WAN device is a device 520 that is interested or engaged in WAN communication. In general, the terms “peer-to-peer” or “P2P” communication and “device-to-device” or “D2D” communication as used herein refers to direct communication between two or more devices 520, without going through any base station 510. For simplicity, the description provided herein uses the term “device-to-device” or “D2D” to refer to such direct communication, although those skilled in the art will appreciate that the terms “peer-to-peer,” “P2P,” “device-to-device,” and “D2D” may be interchangeable in the various aspects and embodiments described herein.

According to various embodiments, a D2D device is a device 520 that is interested or engaged in D2D communication (e.g., a device 520 that has traffic data for another device 520 within proximity of the D2D device). Two devices may be considered to be within proximity of one another, for example, if each device 520 can detect the other device 520. In general, a device 520 may communicate with another device 520 either directly for D2D communication or via at least one base station 510 for WAN communication.

In various embodiments, direct communication between D2D devices 520 may be organized into D2D groups. More particularly, a D2D group generally refers to a group of two or more devices 520 interested or engaged in D2D communication and a D2D link refers to a communication link for a D2D group. Furthermore, in various embodiments, a D2D group may include one device 520 designated as a D2D group owner (or a D2D server) and one or more devices 520 designated as D2D clients that are served by the D2D group owner. The D2D group owner may perform certain management functions such as exchanging signaling with a WAN, coordinating data transmission between the D2D group owner and D2D clients, etc. For example, as shown in FIG. 5, a first D2D group includes the devices 520a and 520b under the coverage of the base station 510a, a second D2D group includes the devices 520c and 520d under the coverage of the base station 510b, a third D2D group includes the devices 520e and 520f under the coverage of different base stations 510b and 510c, and a fourth D2D group includes the devices 520g, 520h and 520i under the coverage of the base station 510c. The devices 520a, 520d, 520f, and 520h may be D2D group owners for their respective D2D groups and the devices 520b, 520c, 520e, 520g, and 520i may be D2D clients in their respective D2D groups. The other devices 520 in FIG. 5 may be engaged in WAN communication.

In various embodiments, D2D communication may occur only within a D2D group and may further occur only between the D2D group owner and the D2D clients associated therewith. For example, if two D2D clients within the same D2D group (e.g., devices 520g and 520i) desire to exchange information, one of the D2D clients may send the information to the D2D group owner (e.g., device 520h) and the D2D group owner may then relay transmissions to the other D2D client. In various embodiments, a particular device 520 may belong to multiple D2D groups and may behave as either a D2D group owner or a D2D client in each D2D group. Furthermore, in various embodiments, a particular D2D client may belong to only one D2D group or belong to multiple D2D groups and communicate with D2D devices 520 in any of the multiple D2D groups at any particular moment. In general, communication may be facilitated via transmissions on the downlink and uplink. For WAN communication, the downlink (or forward link) refers to the communication link from the base stations 510 to the devices 520, and the uplink (or reverse link) refers to the communication link from the devices 520 to the base stations 510. For D2D communication, the D2D downlink refers to the communication link from D2D group owners to D2D clients and the D2D uplink refers to the communication link from D2D clients to D2D group owners. In various embodiments, rather than using WAN technologies to communicate D2D, two or more devices may form smaller D2D groups and communicate D2D on a wireless local area network (WLAN) using technologies such as Wi-Fi, Bluetooth, or Wi-Fi Direct. For example, D2D communication using Wi-Fi, Bluetooth, Wi-Fi Direct, or other WLAN technologies may enable D2D communication between two or more mobile phones, game consoles, laptop computers, or other suitable communication entities.

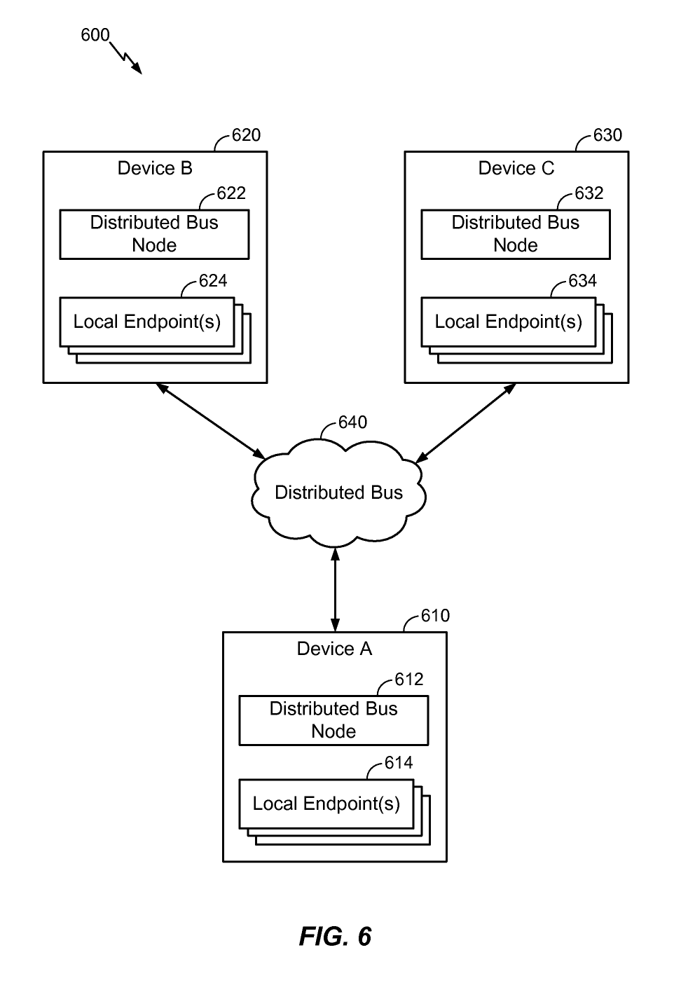

According to various aspects, FIG. 6 illustrates an exemplary environment 600 in which discoverable D2D services may be used to establish a proximity-based distributed bus 640 over which various devices may communicate using D2D technology (e.g., a first device 610, a second device 620, a third device 630 in the example illustrated in FIG. 6). For example, in various embodiments, communications between applications and the like, on a single platform may be facilitated using an interprocess communication protocol (IPC) framework over the distributed bus 640, which may comprise a software bus used to enable application-to-application communications in a networked computing environment where applications register with the distributed bus 640 to offer services to other applications and other applications query the distributed bus 640 for information about registered applications. Such a protocol may provide asynchronous notifications and remote procedure calls (RPCs) in which signal messages (e.g., notifications) may be point-to-point or broadcast, method call messages (e.g., RPCs) may be synchronous or asynchronous, and the distributed bus 640 may handle message routing between the various devices 610, 620, 630 (e.g., via one or more bus routers or “daemons” or other suitable processes that may provide attachments to the distributed bus 640).

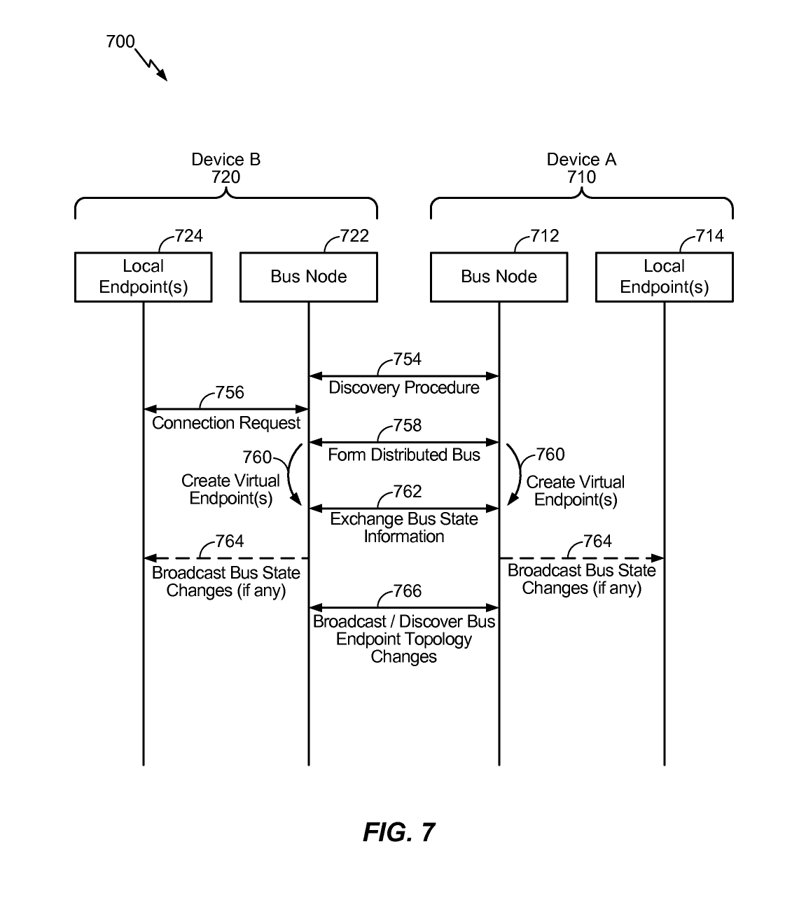

In various embodiments, the distributed bus 640 may be supported by a variety of transport protocols (e.g., Bluetooth, TCP/IP, Wi-Fi, CDMA, GPRS, UMTS, etc.). For example, according to various aspects, the first device 610 may include a distributed bus node 612 and one or more local endpoints 614, wherein the distributed bus node 612 may facilitate communications between the local endpoint(s) 614 associated with the first device 610 and local endpoint(s) 624 and 634 associated with the second device 620 and the third device 630 through the distributed bus 640 (e.g., via distributed bus nodes 622 and 632 on the second device 620 and the third device 630). As will be described in further detail below with reference to FIG. 7, the distributed bus 640 may support symmetric multi-device network topologies and may provide a robust operation in the presence of device drops-outs. As such, the distributed bus 640, which may generally be independent from any underlying transport protocol (e.g., Bluetooth, TCP/IP, Wi-Fi, etc.) may allow various security options, from unsecured (e.g., open) to secured (e.g., authenticated and encrypted), wherein the security options can be used while facilitating spontaneous connections among the first device 610, the second device 620, and the third device 630 without intervention when the various devices 610, 620, 630 come into range or proximity to each other.

According to various aspects, FIG. 7 illustrates an exemplary signaling flow 700 in which discoverable D2D services may be used to establish a proximity-based distributed bus over which a first device (“Device A”) 710 and a second device (“Device B”) 720 may communicate using D2D technology. For example, in the signaling flow 700 shown in FIG. 7, Device A 710 may request to communicate with Device B 720, wherein Device A 710 may a include local endpoint 714 (e.g., a local application, service, etc.), which may make a request to communicate in addition to a bus node 712 that may assist in facilitating such communications. Further, Device B 720 may include a local endpoint 724 with which the local endpoint 714 may be attempting to communicate in addition to a bus node 722 that may assist in facilitating communications between the local endpoint 714 on the Device A 710 and the local endpoint 724 on Device B 720.

In various embodiments, the bus nodes 712 and 722 may perform a suitable discovery mechanism at 754. For example, mechanisms for discovering connections supported by Bluetooth, TCP/IP, UNIX, or the like may be used. At 756, the local endpoint 724 on Device B 720 may request to connect to an entity, service, endpoint etc., available through bus node 722. In various embodiments, the request may include a request-and-response process between local endpoint 724 and bus node 722. At 758, a distributed message bus may be formed to connect bus node 722 to bus node 712 and thereby establish a D2D connection between Device A 710 and Device B 720. In various embodiments, communications to form the distributed bus between the bus nodes 712 and 722 may be facilitated using a suitable proximity-based D2D protocol (e.g., the AllJoyn™ software framework designed to enable interoperability among connected products and software applications from different manufacturers to dynamically create proximal networks and facilitate proximal D2D communication). Alternatively, in various embodiments, a server (not shown) may facilitate the connection between the bus nodes 712 and 722. Furthermore, in various embodiments, a suitable authentication mechanism may be used prior to forming the connection between the bus nodes 712 and 722 (e.g., SASL authentication in which a client may send an authentication command to initiate an authentication conversation). Still further, at 758, the bus nodes 712 and 722 may exchange information about other available endpoints (e.g., the local endpoint(s) 634 on Device C 630 in FIG. 6). In such embodiments, each local endpoint that a bus node maintains may be advertised to other bus nodes, wherein the advertisement may include unique endpoint names, transport types, connection parameters, or other suitable information.

In various embodiments, at 760, the bus node 712 and the bus node 722 may each use obtained information associated with the respective local endpoint(s) 724 and 714 to create virtual endpoints that may represent the real obtained endpoints available through various bus nodes. In various embodiments, message routing on the bus node 712 may use real and virtual endpoints to deliver messages. Further, there may one local virtual endpoint for every endpoint that exists on remote devices (e.g., Device A 710). Still further, such virtual endpoints may multiplex and/or de-multiplex messages sent over the distributed bus (e.g., a connection between bus node 712 and bus node 722). In various embodiments, virtual endpoints may receive messages from the local bus node 712 or 722, just like real endpoints, and may forward messages over the distributed bus. As such, the virtual endpoints may forward messages to the local bus nodes 712 and 722 from the endpoint multiplexed distributed bus connection. Furthermore, in various embodiments, virtual endpoints that correspond to virtual endpoints on a remote device may be reconnected at any time to accommodate desired topologies of specific transport types. In such embodiments, UNIX based virtual endpoints may be considered local and as such may not be considered candidates for reconnection. Further, TCP-based virtual endpoints may be optimized for one hop routing (e.g., the bus nodes 712 and 722 may be directly connected to each other). Still further, Bluetooth-based virtual endpoints may be optimized for a single pico-net (e.g., one master and n slaves) in which the Bluetooth-based master may be the same bus node as a local master node.

In various embodiments, the bus nodes 712 and 722 may exchange bus state information at 762 to merge bus instances and enable communication over the distributed bus. For example, in various embodiments, the bus state information may include a well-known to unique endpoint name mapping, matching rules, routing group, or other suitable information. In various embodiments, the state information may be communicated between the bus nodes 712 and 722 using an interface associated with the respective local endpoint(s) 714 and 724 that may communicate using a distributed bus based local name. In another aspect, the bus nodes 712 and 722 may each maintain a local bus controller responsible for providing feedback to the distributed bus, wherein the bus controller may translate global methods, arguments, signals, and other information into the standards associated with the distributed bus. The bus nodes 712 and 722 may communicate (e.g., broadcast) signals at 764 to inform the respective local endpoint(s) 714 and 724 about any changes introduced during bus node connections, such as described above. In various embodiments, new and/or removed global and/or translated names may be indicated with name owner changed signals. Furthermore, global names that may be lost locally (e.g., due to name collisions) may be indicated with name lost signals. Still further, global names that are transferred due to name collisions may be indicated with name owner changed signals, and unique names that disappear if and/or when the bus nodes 712 and 722 become disconnected, may be indicated with name owner changed signals.

As used above, well-known names may be used to uniquely describe the local endpoint(s) 714 and 724. In various embodiments, when communications occur between Device A 710 and Device B 720, different well-known name types may be used. For example, a device local name may exist only on the bus node 712 associated with Device A 710 to which the bus node 712 directly attaches. In another example, a global name may exist on all known bus nodes 712 and 722, where only one owner of the name may exist on all bus segments. In other words, when the bus nodes 712 and 722 are joined and any collisions occur, one of the owners may lose the global name. In still another example, a translated name may be used when a client is connected to other bus nodes associated with a virtual bus. In such embodiments, the translated name may include an appended end (e.g., a local endpoint 714 with well-known name “org.foo” connected to the distributed bus with Globally Unique Identifier “1234” may be seen as “G1234.org.foo”).

In various embodiments, the bus nodes 712 and 722 may communicate (e.g., broadcast) signals at 766 to inform other bus nodes of changes to endpoint bus topologies. Thereafter, traffic from the local endpoint 714 may move through virtual endpoints to reach intended the local endpoint(s) 724 on Device B 720. Further, in operation, communications between the local endpoint(s) 714 and 724 may use routing groups. In various embodiments, routing groups may enable endpoints to receive signals, method calls, or other suitable information from a subset of endpoints. As such, a routing name may be determined by an application connected to the bus nodes 712 or 722. For example, a D2D application may use a unique, well-known routing group name built into the application. Further, the bus nodes 712 and 722 may support registering and/or de-registering of the local endpoint(s) 714 and 724 with routing groups. In various embodiments, routing groups may have no persistence beyond a current bus instance. In another aspect, applications may register for their preferred routing groups each time they connect to the distributed bus. Still further, groups may be open (e.g., any endpoint can join) or closed (e.g., only the creator of the group can modify the group). Yet further, the bus nodes 712 or 722 may send signals to notify other remote bus nodes of additions, removals, or other changes to routing group endpoints. In such embodiments, the bus nodes 712 or 722 may send a routing group change signal to other group members whenever a member is added and/or removed from the group. Further, the bus nodes 712 or 722 may send a routing group change signal to one or more endpoints that disconnect from the distributed bus without the one or more endpoints first removing themselves from the routing group.

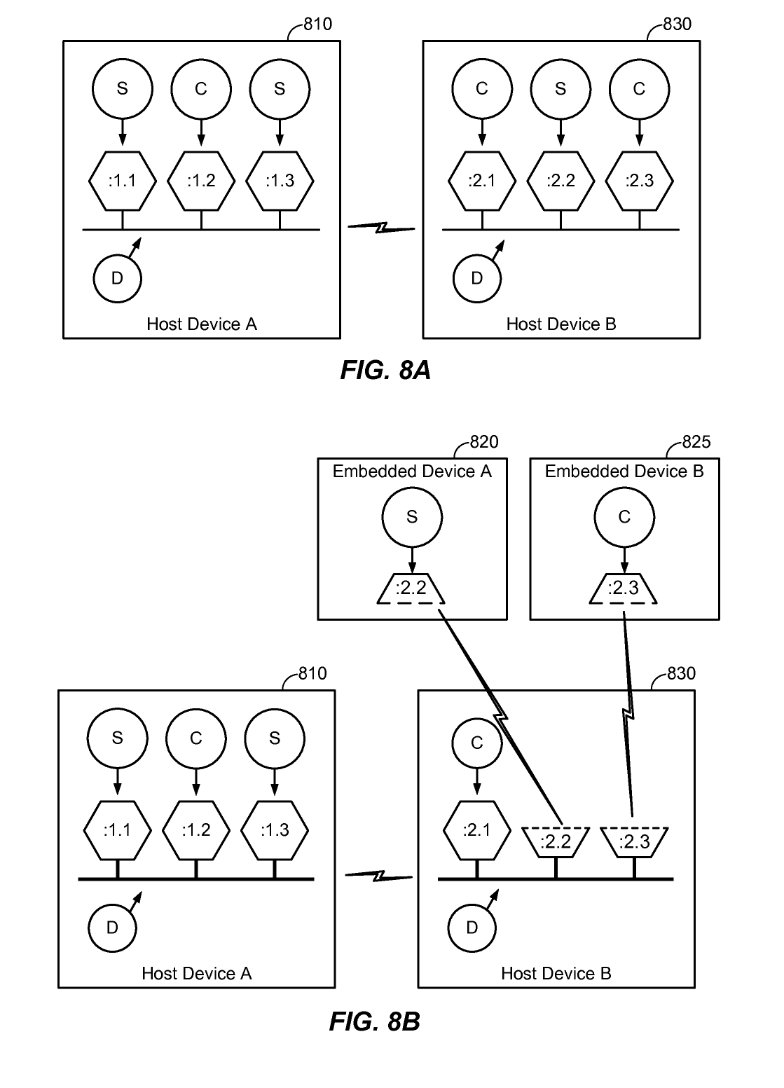

According to various aspects, FIG. 8A illustrates an exemplary proximity-based distributed bus that may be formed between a first host device 810 and a second host device 830 to enable D2D communication between the first host device 810 and the second host device 830. More particularly, as described above with respect to FIG. 6, the basic structure of the distributed bus 640 may comprise multiple bus segments that reside on separate physical host devices. Accordingly, in FIG. 8A, each segment of the distributed bus 640 may be located on one of the host devices 810, 830, wherein the host devices 810, 830 each execute a local bus router (or “daemon”) that may implement the bus segments located on the respective host device 810, 830. For example, in FIG. 8A, each host device 810, 830 includes a bubble labeled “D” to represent the bus router that implements the bus segments located on the respective host device 810, 830. Furthermore, one or more of the host devices 810, 830 may have several bus attachments, where each bus attachment connects to the local bus router. For example, in FIG. 8A, the bus attachments on host devices 810, 830 are illustrated as hexagons that each correspond to either a service (S) or a client (C) that may request a service.

However, in certain cases, embedded devices may lack sufficient resources to run a local bus router. Accordingly, FIG. 8B illustrates an exemplary architecture in which one or more embedded devices 820, 825 can connect to a host device (e.g., host device 830) to connect to a proximity-based distributed bus segment on the host device and thereby engage in D2D communication (e.g., with the host device 830 or with other host devices 810 and/or embedded devices 825 that are attached to the distributed bus via the host device 830). As such, the embedded devices 820, 825 may generally “borrow” the bus router running on the host device 830, whereby FIG. 8B shows an arrangement where the embedded devices 820, 825 are physically separate from the host device 830 running the borrowed bus router that manages the distributed bus segment on which the embedded devices 820, 825 reside. In general, the connection between the embedded devices 820, 825 and the host device 830 may be made according to the Transmission Control Protocol (TCP) and the network traffic flowing between the embedded devices 820, 825 and the host device 830 may comprise messages that implement bus methods, bus signals, and properties flowing over respective sessions in a similar manner to that described in further detail above with respect to FIGS. 6-7.

More particularly, the embedded devices 820, 825 may connect to the host device 830 according to a discovery and connection process that may be conceptually similar to the discovery and connection process between clients and services, wherein the host device 830 may advertise a well-known name (e.g., “org.alljoyn.BusNode”) that signals an ability or willingness to host the embedded devices 820, 825. In one use case, the embedded devices 820, 825 may simply connect to the “first” host device that advertises the well-known name. However, if the embedded devices 820, 825 simply connect to the first host device that advertises the well-known name, the embedded devices 820, 825 may not have any knowledge about the type associated with the host device (e.g., whether the host device 830 is a mobile device, a set-top box, an access point, etc.), nor would the embedded devices 820, 825 have any knowledge about the load status on the host device. Accordingly, in other use cases, the embedded devices 820, 825 may adaptively connect to the host device 830 based on information that the host devices 810, 830 provide when advertising the ability or willingness to host other devices (e.g., embedded devices 820, 825), which may thereby join the distributed bus according to properties associated with the host devices 810, 830 (e.g., type, load status, etc.) and/or requirements associated with the embedded devices 820, 825 (e.g., a ranking table that expresses a preference to connect to a host device from the same manufacturer).

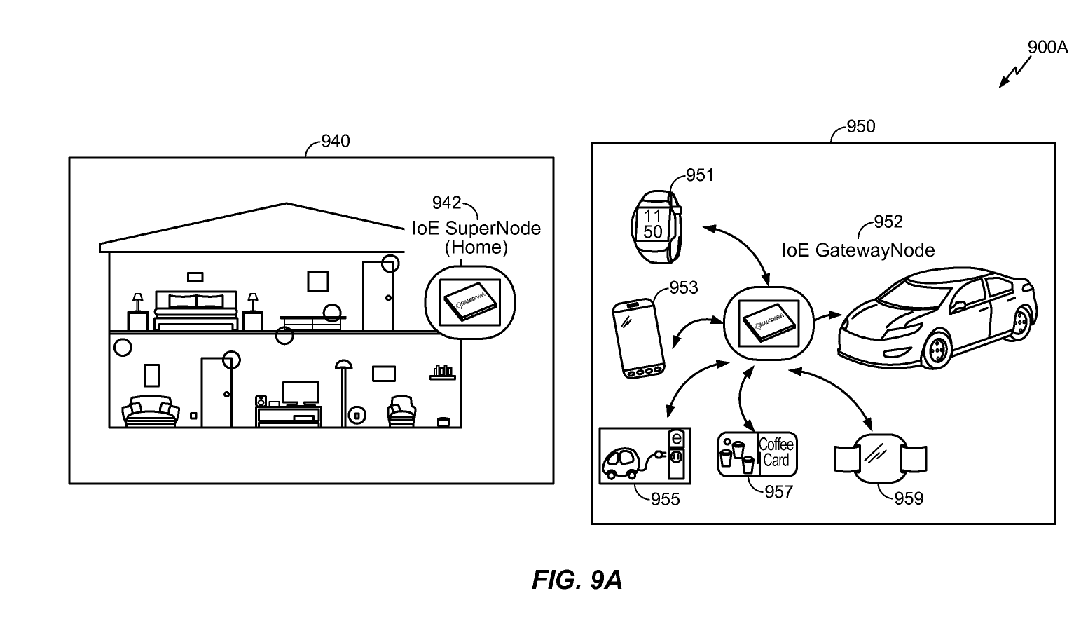

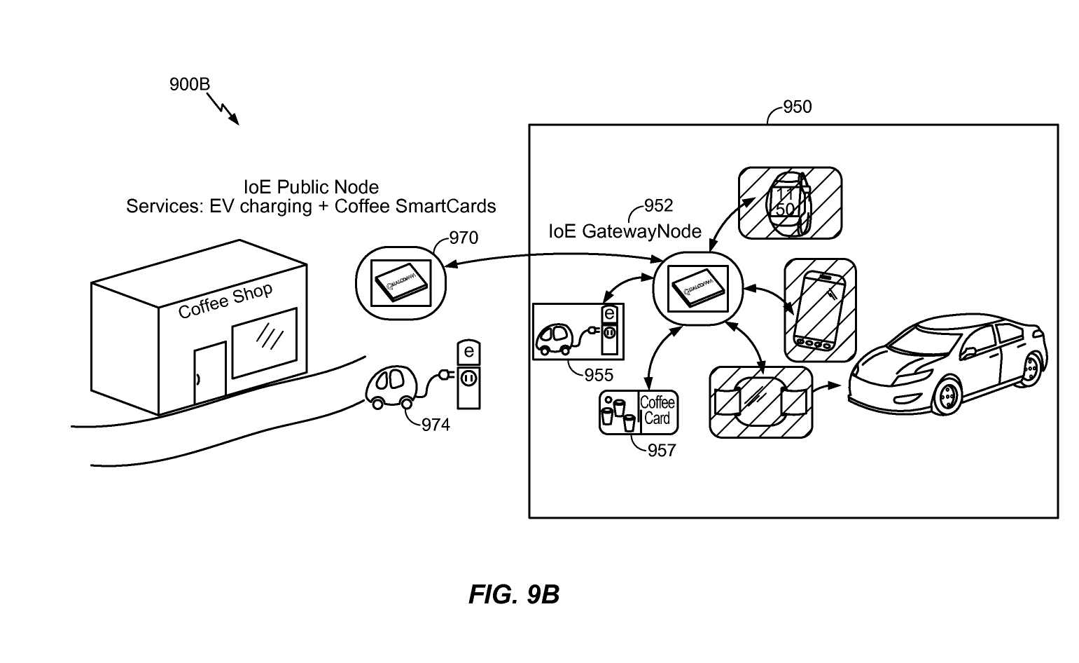

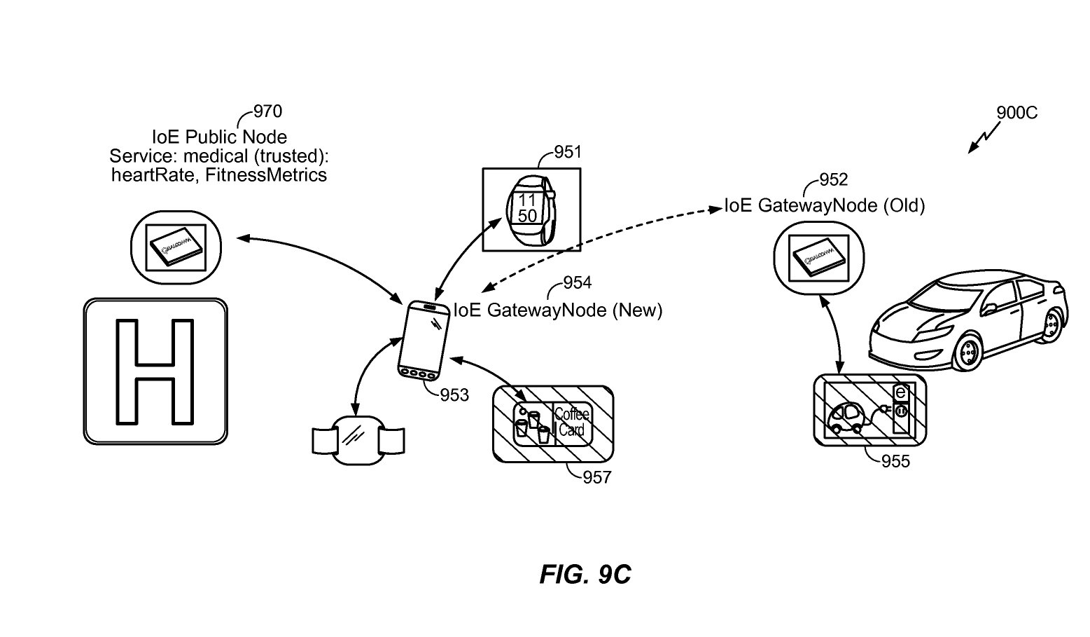

According to various aspects, FIGS. 9A-9C illustrate exemplary contexts in which a dynamic ad hoc gateway may provide inter-network communication among different IoT networks and/or IoT subnetworks. In particular, the dynamic ad hoc gateway may generally be assigned within a mobile IoT network and/or other suitable IoT networks (or subnetworks) that have dynamic or otherwise contextually dependent aspects, wherein the dynamic ad hoc gateway may be configured to provide inter-network communication among different IoT networks and/or IoT subnetworks. In various embodiments, the dynamic ad hoc gateway may be assigned statically, hierarchically, dynamically, through a voting procedure, and/or any suitable combination thereof. For example, a static assignment scheme may assign a particular IoT device, if present, to be the dynamic ad hoc gateway, while a hierarchical assignment scheme may rank various IoT devices and assign the highest ranked IoT device to be the dynamic ad hoc gateway (e.g., a smart phone may be assigned a highest rank and a smart watch may be assigned a next highest rank, the IoT devices may be ranked according to how frequently each IoT device is assigned to be dynamic ad hoc gateway, etc.). Furthermore, in an assignment scheme that utilizes the voting procedure, various IoT devices in a particular IoT subnetwork may vote to elect one IoT device to be the dynamic ad hoc gateway, while a dynamic assignment scheme may be controlled at a home gateway, which may receive a request to assign the dynamic ad hoc gateway and relevant context information from the IoT subnetwork and dynamically assign the ad hoc gateway according to the relevant context information. In various embodiments, once the dynamic ad hoc gateway has been appropriately assigned, a trusted interface from the IoT subnetwork to one or more external IoT subnetworks may be provided via the dynamic ad hoc gateway, which may further provide functionality to selectively expose and/or selectively hide portions of a topology associated with the IoT subnetwork(s). Furthermore, to enforce security and privacy measures, the dynamic ad hoc gateway may require that all communications occur over the trusted interface and further limit the level of communication according to context (e.g., allowing different levels of communication between a personal IoT subnetwork and a trusted external network versus public and/or other untrusted external networks). Further still, the level of communication can be dynamically adopted depending on a user context (e.g., permitting certain communications in a car subnetwork when the owner is in the car versus when the owner is not in the car but there is a need to interact with a service center network).

According to various aspects, as mentioned above, the dynamic ad hoc gateway may be selected or otherwise assigned using static, hierarchical, dynamic, and/or voting-based mechanisms, each of which may employ one or more rules, heuristics, and/or other contextual information to select or otherwise assign the dynamic ad hoc gateway. Furthermore, in various embodiments, the one or more rules, heuristics, and/or other contextual information may be utilized in assignment schemes that are based on any suitable combination of the static, hierarchical, dynamic, and/or voting-based assignment mechanisms. For example, in various embodiments, the rules, heuristics, and/or other contextual information may be location-based, wherein certain IoT devices may be designated as the dynamic ad hoc gateway in certain locations (e.g., a smartphone may be designated as the gateway in an office location, a car may be the gateway when on the road, a smartwatch may be the gateway while on a hike, etc.). In another example, the dynamic ad hoc gateway may be assigned based on certain services that IoT devices in a particular subnetwork need and/or certain services that are offered at visiting/visited IoT networks. For example, when a user visits a coffee shop that has an electric vehicle charging station and needs to charge an electric vehicle, the dynamic ad hoc gateway may be a smartphone that runs an application that supports payments or other interactions at the coffee shop or the electric vehicle plugged into the charging station at the coffee shop, and the voting procedure may be used to resolve any conflicts that may arise due to the smartphone and the electric vehicle having similar qualifications to be the dynamic ad hoc gateway. In still other examples, the dynamic ad hoc gateway may be assigned based on supported interfaces (e.g., to match communication interfaces with communication interfaces used at visiting/visited IoT networks), heuristics or trust (e.g., a particular IoT device frequently selected to be the gateway may be ranked higher and therefore more likely to be selected again in the future), and/or other suitable criteria. Furthermore, the dynamic ad hoc gateway may aggregate communication within the managed IoT subnetwork to improve computational efficiency and support handoffs to another gateway node in response to topology changes (e.g., when one or more IoT devices leave and/or join the proximal cloud that defines the IoT subnetwork, when the context associated with the IoT subnetwork changes from communicating with a trusted home network to an untrusted public network, from an untrusted public network to a trusted public network, etc.).

Additionally, as will be further described in more detail below, the dynamic ad hoc gateway may enable selective topology hiding and/or selective topology exposure in an IoT network based on trust relationships between various IoT nodes and networks, wherein the selective topology hiding and/or exposure may depend on services that hosting/visited IoT nodes advertise and that visiting/guest IoT gateway nodes discover. Accordingly, the dynamic ad hoc gateway may only make those IoT devices that are providing and/or utilizing advertised or required services visible outside the proximal IoT subnetwork, which may be determined according to predefined, dynamic, or user-approved rules that define trust handshakes between the dynamic ad hoc gateway and a gateway node associated with the overall IoT network.

For example, FIG. 9A illustrates an exemplary context 900A that may enable communication between a home IoT network 940 and a mobile IoT subnetwork 950 (e.g., within a vehicle), wherein the communication between the home IoT network 940 and the mobile IoT subnetwork 950 may be managed via a gateway node 942 located in the home IoT network 940 and an ad hoc gateway 952 that may be dynamically assigned in the vehicle IoT subnetwork 950. For example, as shown in FIG. 9A, the vehicle IoT subnetwork 950 may include various IoT devices that may be used in or otherwise associated with a vehicle, which may include a wearable activity sensor 951, a smartphone 953, an electric vehicle charging system 955, a coffee shop smartcard 957 having an active and/or passive communication interface, a smartwatch 959, and/or other suitable IoT devices. As such, one of the IoT devices in the vehicle IoT subnetwork 950 may be elected the dynamic ad hoc gateway 952 according to one or more of the assignment mechanisms described above, and the elected dynamic ad hoc gateway 952 may then communicate with the gateway node 942 located in the home IoT network 940 to facilitate inter-network communication between the home IoT network 940 and the vehicle IoT subnetwork 950. Furthermore, because the gateway node 942 located in the home IoT network 940 and the elected dynamic ad hoc gateway 952 associated with the vehicle IoT subnetwork 950 may each have a trusted status, the topology associated with the home IoT network 940 may be open such that the IoT devices in the vehicle IoT subnetwork 950 may be granted full access to any services and/or information that may be available and/or needed from the home IoT network 940. Likewise, the topology associated with the vehicle IoT subnetwork 950 may be open such that the home IoT network 940 may have full access to any services and/or information that may be available and/or needed from the vehicle IoT subnetwork 950.

In contrast, FIG. 9B illustrates another context 900B where the dynamic ad hoc gateway 952 may implement certain topology hiding functions when communicating with a public gateway node 970 that does not have a trusted relationship. More particularly, in the exemplary context 900B shown in FIG. 9B, the vehicle IoT subnetwork 950 may be visiting a coffee shop that provides an external IoT network having the public gateway node 970, which may be advertising or otherwise offering services associated with an electric vehicle charging station 974 and smartcard services associated with the coffee shop. Accordingly, the dynamic ad hoc gateway 952 may hide a topology associated with the vehicle IoT subnetwork 950 and the IoT devices located therein until an appropriate trust relationship has been established based on heuristics, configurations, user intervention, service provisioning, and/or other suitable criteria. For example, in response to the dynamic ad hoc gateway 952 discovering that the public gateway node 970 is advertising that the external IoT network offers services that include the electric vehicle charging station 974 and coffee shop smartcards, the dynamic ad hoc gateway 952 may selectively expose only the electric vehicle charging system 955 and the coffee shop smartcard 957 that have capabilities to use the services offered through the public gateway node 970.

Furthermore, as noted above, the dynamic ad hoc gateway 952 may support changes to the topology hiding functions according to changes in the external IoT gateway node 970 and/or the services offered thereby. For example, in another context 900C as shown in FIG. 9C, the dynamic ad hoc gateway 952 may discover that a public gateway node 970 at a hospital offers trusted medical services that include heart rate and fitness metric monitoring. In that case, supposing that the electric vehicle charging system 955 was elected to be the dynamic ad hoc gateway 952 at the coffee shop offering services associated with the electric vehicle charging station 974 as shown in FIG. 9B, the IoT subnetwork that includes the wearable activity sensor 951, the smartphone 953, the electric vehicle charging system 955, the coffee shop smartcard 957, and the smartwatch 959 may be reconfigured at the hospital setting to elect the smartphone 953 as a new dynamic ad hoc gateway 954 in the hospital setting, wherein the smartphone 953 acting as the new dynamic ad hoc gateway 954 may selectively expose and aggregate communications associated with the wearable activity sensor 951 and the smartwatch 959 that have capabilities to use the trusted heart rate and fitness metric monitoring services offered through the public gateway node 970 at the hospital setting. Furthermore, when acting as the new dynamic ad hoc gateway 954, the smartphone 953 may hide all other IoT devices from the public gateway node 970 at the external hospital IoT network. In other words, certain portions of the IoT subnetwork topology may be exposed due to the trust relationship with the public gateway node 970 at the hospital while other portions of the IoT subnetwork topology that do not need or have capabilities to utilize the services offered at the hospital may be hidden.

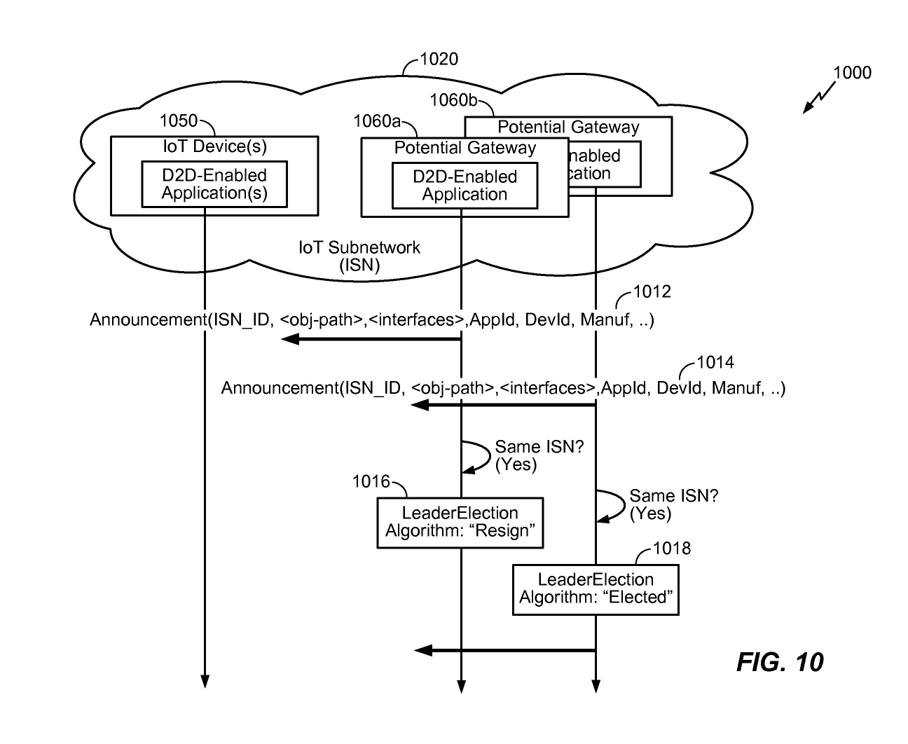

According to various aspects, as will be described in further detail herein, FIGS. 10-13 illustrate exemplary call flows that may be used to elect, register with, and communicate with a dynamic ad hoc gateway that may act as a proxy to facilitate inter-network communication with external IoT subnetworks. In general, the call flows shown in FIGS. 10-13 may utilize an appropriate communication protocol that allows various IoT devices to exchange and coordinate communications in mobile or other dynamic contexts. For example, in various embodiments, the call flows shown in FIGS. 10-13 may utilize a communication framework that supports proximity-based direct device-to-device (D2D) communication among heterogeneous IoT devices, such as the AllJoyn™ software framework that heterogeneous devices and software applications can utilize to dynamically create proximal networks and facilitate proximal D2D communication, as described in further detail above with reference to FIGS. 5-8.

According to various aspects, FIG. 10 illustrates an exemplary call flow 1000 that may be used to elect a dynamic ad hoc gateway in an IoT subnetwork (ISN) 1020. For example, in various embodiments, the call flow 1000 shown in FIG. 10 may be used to elect the dynamic ad hoc gateway when initially configuring the ISN 1020 and/or to reconfigure the assigned dynamic ad hoc gateway in response to one or more changes to a topology or other context associated with the ISN 1020 (e.g., when one or more IoT devices leave and/or join the proximal cloud that defines the ISN 1020, when the context associated with the ISN 1020 changes from communicating with a trusted home network to an untrusted public network, from an untrusted public network to a trusted public network, etc.). For example, when electing the dynamic ad hoc gateway, one or more IoT devices associated with the ISN 1020 that have sufficient capabilities to serve as the dynamic ad hoc gateway may be potential gateways, where the example shown in FIG. 10 includes two potential gateway IoT devices (i.e., IoT devices 1060a and 1060b).

In various embodiments, as depicted at 1012 and 1014, the potential gateways, which include at least the potential gateways 1060a and 1060b, may each transmit an announcement message to advertise connectivity and capability information to the other potential gateways and to one or more IoT devices 1050 that are part of the ISN 1020 despite not being potential gateways (e.g., a smartcard IoT device 1050 that has limited communication and processing capabilities). In various embodiments, the announcement message(s) transmitted from each potential gateway 1060a, 1060b, etc. may advertise an identifier associated with an ISN to which the potential gateways 1060a, 1060b, etc. belong (e.g., ISN 1020 in the illustrated example), an object path and interfaces to facilitate communication with one or more peer-to-peer enabled applications on the potential gateways 1060a, 1060b, etc., an identifier associated with the one or more peer-to-peer enabled applications, a device identifier and a manufacturer identifier, and/or any other suitable connectivity and capability information associated with the potential gateways 1060a, 1060b, etc. For example, assuming that the peer-to-peer enabled applications utilize the AllJoyn™ software framework described above with reference to FIGS. 5-8, the announcement message may generally specify identifiers associated with a standard interface that the potential gateways 1060a, 1060b, etc. implement to host a local endpoint on a proximity-based distributed bus and provide basic bus attachment functionality, and the object path may be structured to differentiate different interface implementations and thereby identify the locally hosted bus endpoints. However, those skilled in the art will appreciate that the announcement message may take other suitable forms through which the potential gateways 1060a, 1060b, etc. can advertise the connectivity and capability information associated therewith and through which heterogeneous IoT devices can process and thereby evaluate the connectivity and capability information advertised from the potential gateways 1060a, 1060b, etc.

In various embodiments, once the potential gateways 1060a, 1060b, etc. have transmitted the announcement messages associated therewith, the announcement messages may be evaluated to determine whether the potential gateways 1060a, 1060b, etc. are associated with the same ISN. In particular, if the potential gateways 1060a, 1060b, etc. are associated with different ISNs, each may become the dynamic ad hoc gateway 1060 within that respective ISN without conflict. However, where the potential gateways 1060a, 1060b, etc. are associated with the same ISN, as in FIG. 10 where each potential gateway 1060a, 1060b, etc. is associated with ISN 1020, a voting procedure (or leader election algorithm) may be carried out to elect one as the dynamic ad hoc gateway 1060 within the ISN 1020. For example, as depicted at 1016, FIG. 10 illustrates an exemplary scenario where the potential gateway 1060a may resign in response to determining that the other potential gateway 1060b should be elected, or alternatively where the IoT devices 1050 associated with the ISN 1020 vote to elect the potential gateway 1060b, as depicted at 1018. As such, once the potential gateway 1060b has been elected, the potential gateway 1060b may become the dynamic ad hoc gateway (at least until if and/or when any context changes such that the dynamic ad hoc gateway assignment may need to be re-evaluated) and transmit a further announcement message to signal that the various IoT devices 1050 within the ISN 1020, which now include the unelected potential gateway 1060a, should communicate with the (elected) potential gateway 1060b over a secure private network that the elected potential gateway 1060b establishes within the ISN 1020 to access an external interface from the ISN 1020.

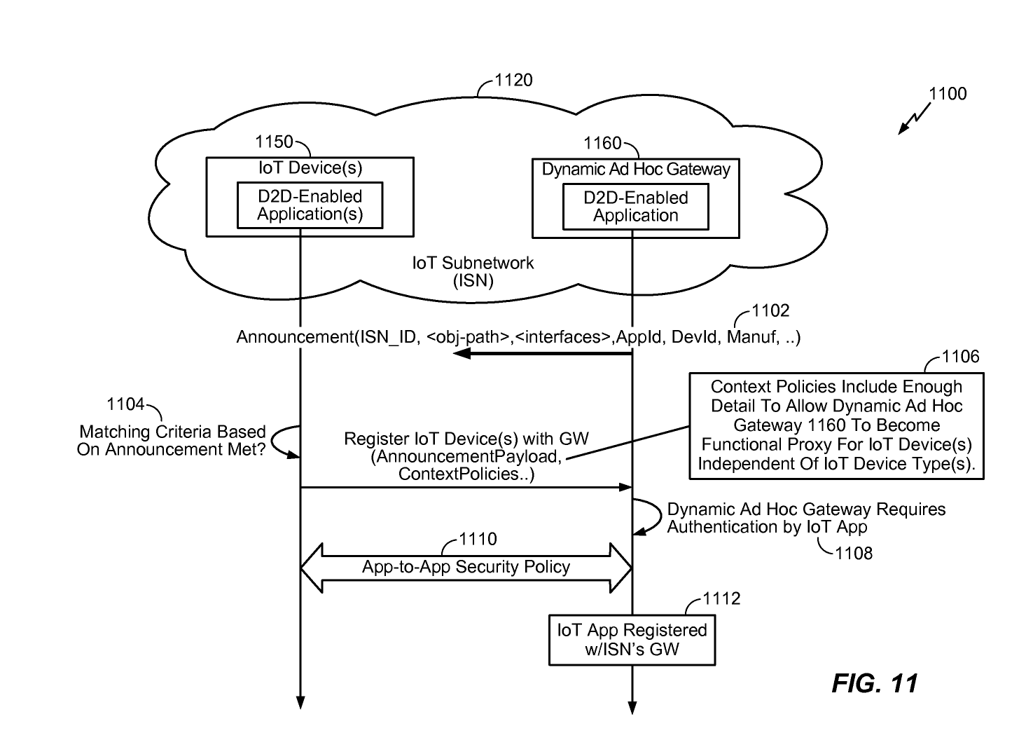

According to various aspects, FIG. 11 illustrates an exemplary call flow 1100 to register with a dynamic ad hoc gateway in an IoT subnetwork such that connected IoT devices 1150 within an ISN 1120 may access services and/or otherwise access an external interface from the ISN 1120. In particular, the first message shown in FIG. 11 may generally correspond to the last message shown in FIG. 10, wherein a dynamic ad hoc gateway 1160 that has been assigned within the ISN 1120 may transmit an announcement message to enable one or more IoT devices 1150 within the ISN 1120 to communicate with the dynamic ad hoc gateway 1160, as depicted at 1102. As such, in response to the IoT device(s) 1150 receiving the announcement message from the dynamic ad hoc gateway 1160, the IoT device(s) 1150 may determine whether the information conveyed in the announcement matches one or more registration criteria associated with the IoT device(s) 1150, as depicted at 1104. If so, the IoT device(s) 1150 may then transmit a registration message to the dynamic ad hoc gateway 1160, as depicted at 1106, wherein the registration message may include an announcement payload, one or more context policies, and/or any other suitable information that may enable the dynamic ad hoc gateway 1160 to manage communications with the IoT device(s) 1150. For example, in various embodiments, the context policies included in the registration message transmitted to the dynamic ad hoc gateway 1160 may generally include sufficient details to allow the dynamic ad hoc gateway 1160 to act as a functional proxy for the IoT device(s) 1150 independent of any type(s) associated therewith. In various embodiments, in response to receiving the registration message from the IoT device(s) 1150, the dynamic ad hoc gateway 1160 may then determine whether there is a need to authenticate the registering IoT device(s) 1150, as depicted at 1108, in which case a connection may be established between peer-to-peer applications running on the dynamic ad hoc gateway 1160 and the IoT device(s) 1150 to implement an application-to-application security policy procedure, as depicted at 1110. In response to suitably authenticating the IoT device(s) 1150 through the application-to-application security policy procedure, the IoT device(s) 1150 may then be registered with the dynamic ad hoc gateway 1160 within the ISN 1120 and ready to request external services or engage in inter-network communication through the dynamic ad hoc gateway 1160, as depicted at 1112. For example, in various embodiments, a set of functionality that the IoT device(s) 1150 exchange with the dynamic ad hoc gateway 1160 and is subsequently exposed over the external interface to request the external services or otherwise engage in the inter-network communication at 1112 may be based on the application-to-application security policy implemented at 1110 when the secure session is established with the dynamic ad hoc gateway 1160.

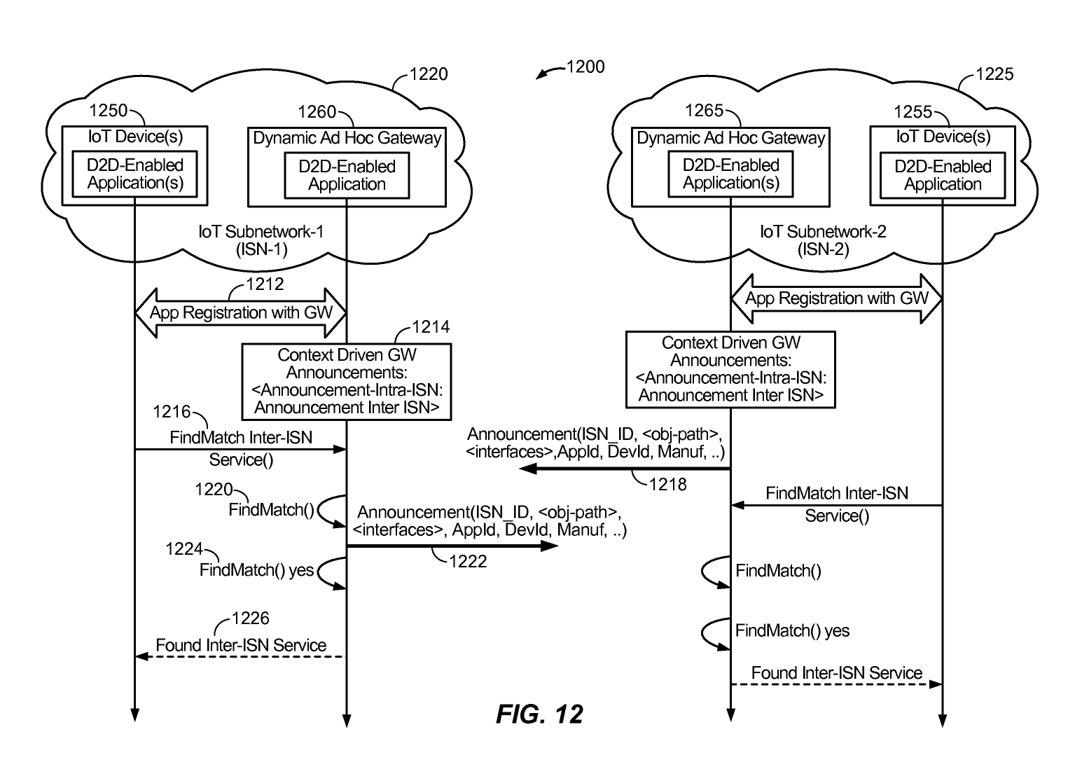

According to various aspects, FIG. 12 illustrates an exemplary call flow 1200 in which dynamic ad hoc gateways in different IoT subnetworks may facilitate inter-network communication between the different IoT subnetworks. In particular, the call flow 1200 shown in FIG. 12 may involve communication between a first dynamic ad hoc gateway 1260 within a first ISN (ISN-1) 1220 and a second dynamic ad hoc gateway 1265 within a second ISN (ISN-2) 1225. Accordingly, one or more IoT devices 1250 within ISN-1 1220 may initially register with the first dynamic ad hoc gateway 1260 according to the call flow 1100 shown in FIG. 11, as depicted at 1212, and one or more IoT devices 1255 within ISN-2 1225 may initially register with the second dynamic ad hoc gateway 1265 in a similar manner. As such, to facilitate inter-network communication between ISN-1 1220 and ISN-2 1225, the dynamic ad hoc gateways 1260, 1265 may transmit context-driven announcements that include intra-ISN announcements transmitted internally within the respective ISNs and inter-ISN announcements transmitted to external ISNs, as depicted at 1214. For example, the IoT devices 1250, 1255 within each ISN 1220, 1225 may request inter-ISN services from the local dynamic ad hoc gateways 1260, 1265, as depicted at 1216, and the local dynamic ad hoc gateways 1260, 1265 may then may transmit inter-ISN announcements to advertise services within the respective ISNs that are being offered to external ISNs and further to find services offered by external ISNs that are needed within the managed ISN, as depicted at 1218, 1220, 1222, and 1224. Accordingly, the dynamic ad hoc gateways 1260, 1265 may aggregate service requests received from the IoT devices 1250, 1255 within the managed ISNs, request the services from external ISNs on behalf of the IoT devices 1250, 1255 within the managed ISNs, and provision the IoT devices 1250, 1255 within the managed ISNs with any services that were requested from and found on external ISNs, as depicted at 1226. Furthermore, as described in further detail above, the inter-ISN announcements transmitted to external ISNs may be structured to selectively hide at least a portion of the managed ISN (e.g., exposing only a portion of the managed ISN that can access services that a particular external ISN may be offering).

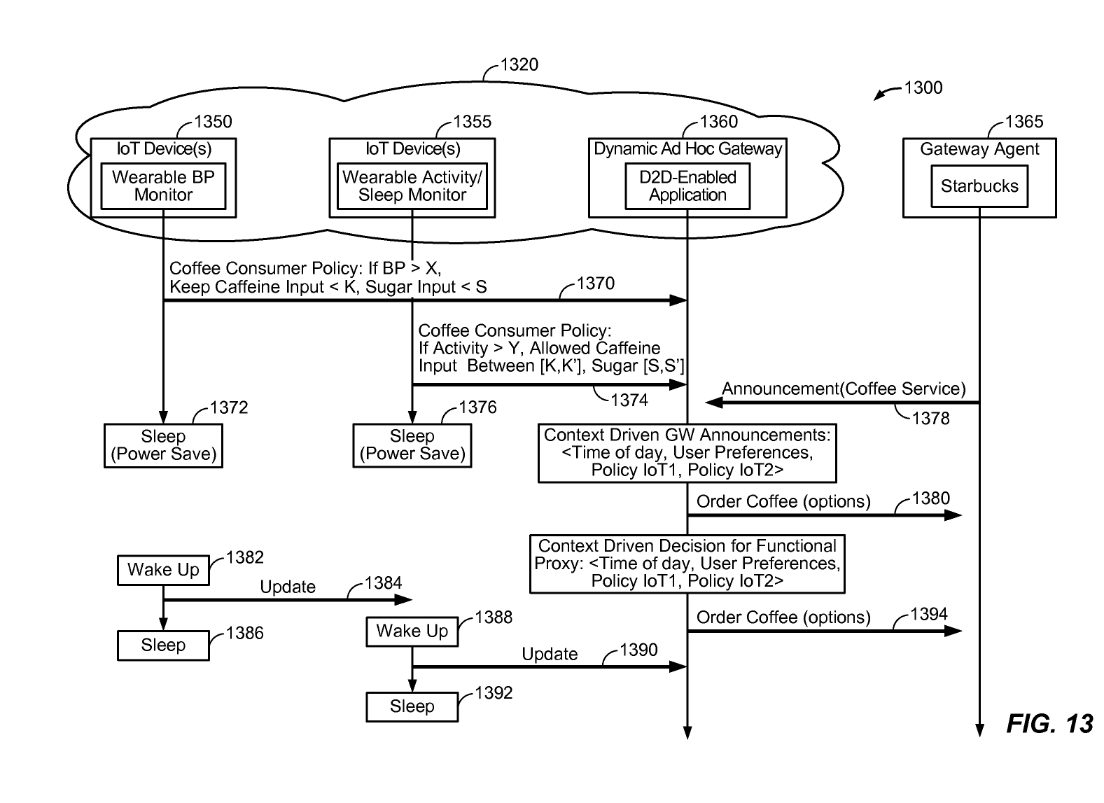

According to various aspects, FIG. 13 illustrates an exemplary call flow 1300 in which a dynamic ad hoc gateway 1360 in one ISN 1320 may act as a functional proxy to facilitate inter-network communication with a gateway agent 1365 or other suitable entity in another ISN. In particular, as shown in FIG. 13, the ISN 1320 may include a first IoT device 1350 that corresponds to, includes, or is otherwise coupled to a wearable blood pressure monitor, a second IoT device 1355 that corresponds to, includes, or is otherwise coupled to a wearable activity and/or sleep monitor, and the dynamic ad hoc gateway 1360 that may act as a gateway agent to provide a functional proxy that may facilitate inter-network communication with the gateway agent 1365 in the other ISN (e.g., a coffee establishment). In that context, the first IoT device 1350 and the second IoT device 1355 may each transmit one or more context policies to the dynamic ad hoc gateway 1360 in order to provide the dynamic ad hoc gateway 1360 with sufficient details to allow the dynamic ad hoc gateway 1160 to act as a functional proxy to request services at the coffee establishment for the IoT devices 1350, 1355. For example, at 1370, the first IoT device 1350 may transmit a coffee consumer policy to the dynamic ad hoc gateway 1360 to indicate that if the blood pressure monitor detects blood pressure above a certain value, caffeine input should remain below a particular value and sugar input should remain below another value. In a similar respect, at 1374, the second IoT device 1355 may transmit a coffee consumer policy to the dynamic ad hoc gateway 1360 to indicate that if detected activity exceeds a certain value, caffeine input and sugar input may be allowed within a particular range (e.g., ranges having respective lower values that correspond to the caffeine and sugar input limitations specified in the context policy from the first IoT device 1350).

At that point, the dynamic ad hoc gateway 1360 may have sufficient input from the first IoT device 1350 and the second IoT device 1355 to determine whether coffee can be ordered for the user associated with the wearable blood pressure monitor and the wearable activity/sleep monitor, whereby the first IoT device 1350 and the second IoT device 1355 may enter a sleep state or other suitable power saving mode at 1372 and 1376, respectively, because the dynamic ad hoc gateway 1360 can independently assess whether to order coffee services based on the coffee consumer policies received therefrom and the current blood pressure and activity monitored on the first IoT device 1350 and the second IoT device 1355. Accordingly, at 1378, the dynamic ad hoc gateway 1360 may detect an announcement from the gateway agent 1365 or other suitable entity at the coffee establishment indicating that coffee services are available through the gateway agent and determine whether to order the coffee services in a context-driven manner. In various embodiments, the dynamic ad hoc gateway 1360 may consider the time of day (e.g., not ordering coffee when a user may be asleep or will be going to sleep soon), any applicable user preferences (e.g., preferred coffee drinks), and the coffee consumer policies in determining whether to order the coffee services, which may depend on the current blood pressure of the user as reported from the first IoT device 1350 and/or the current activity level of the user as reported from the second IoT device 1355. For example, in response to determining that the current blood pressure of the user is less than or equal to X and the current activity level of the user is above Y, the dynamic ad hoc gateway 1360 may communicate with the gateway agent 1365 in the other ISN to order coffee for the user, as depicted at 1380, provided that the coffee would not cause the user's caffeine and/or sugar input to exceed the upper bound on the range defined in the context policy received from the second IoT device 1355 (e.g., a sugar-free coffee drink may be ordered if the coffee order would not exceed the upper bound of the allowed caffeine input but would exceed the upper bound of the allowed sugar input, a decaffeinated coffee drink may be ordered if the coffee order would exceed the upper bound of the allowed caffeine input, etc.). Furthermore, at 1382 and 1384, the first IoT device 1350 may periodically wake up in order to provide updated blood pressure readings to the dynamic ad hoc gateway 1360 and then re-enter the sleep state at 1386. Similarly, at 1388 and 1390, the second IoT device 1355 may wake up to provide updated activity level readings to the dynamic ad hoc gateway 1360 and then re-enter the sleep state at 1392. Accordingly, at 1394, the dynamic ad hoc gateway 1360 may determine whether to order the coffee services based on the updated readings received at 1384 and 1390 such that coffee may be ordered in response to appropriate changes in context (e.g., the blood pressure reading has dropped and the activity level has increased from an earlier time when coffee could not be ordered without compromising the policies received from the first IoT device 1350 and the second IoT device 1355).

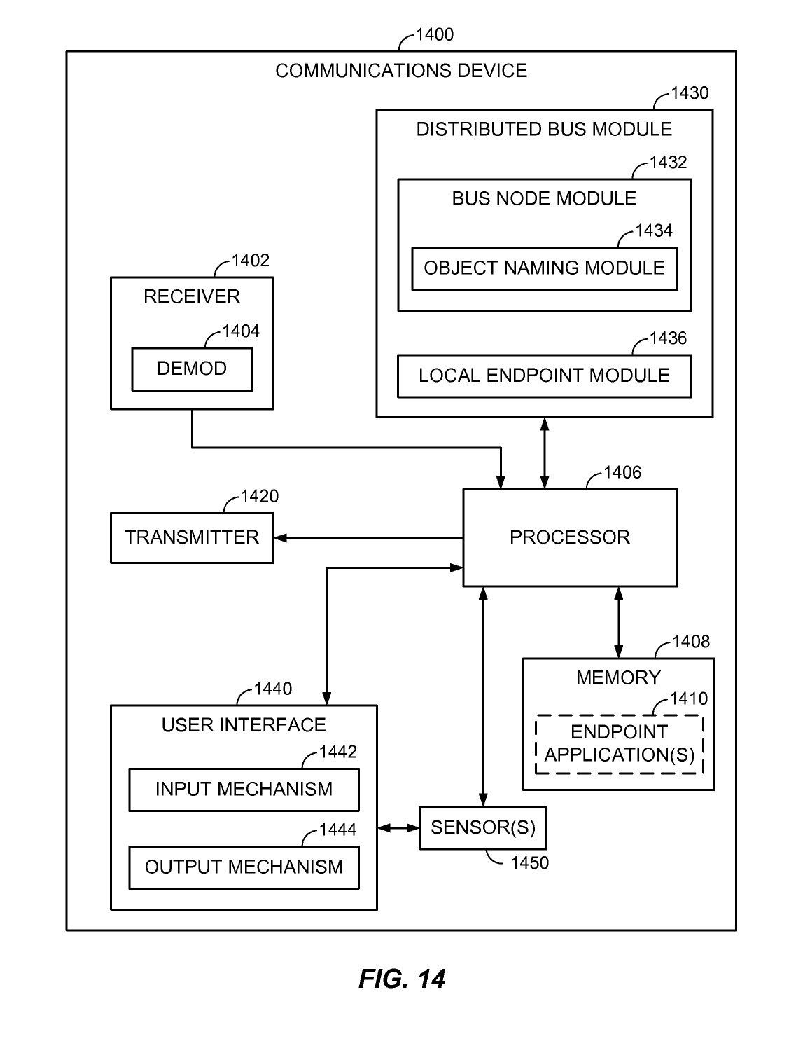

According to various aspects, FIG. 14 illustrates an exemplary communication device 1400 that may support direct D2D communication with other proximal devices, whereby the communication device 1400 shown in FIG. 14 may correspond to any suitable device described above in relation to the various aspects and embodiments disclosed herein. In various embodiments, as shown in FIG. 14, the communication device 1400 may comprise a receiver 1402 that may receive a signal from, for instance, a receive antenna (not shown), perform typical actions on the received signal (e.g., filtering, amplifying, downconverting, etc.), and digitize the conditioned signal to obtain samples. The receiver 1402 can comprise a demodulator 1404 that can demodulate received symbols and provide them to a processor 1406 for channel estimation. The processor 1406 can be dedicated to analyzing information received by the receiver 1402 and/or generating information for transmission by a transmitter 1420, control one or more components of the communication device 1400, and/or any suitable combination thereof.

In various embodiments, the communication device 1400 can additionally comprise a memory 1408 operatively coupled to the processor 1406, wherein the memory 1408 can store received data, data to be transmitted, information related to available channels, data associated with analyzed signal and/or interference strength, information related to an assigned channel, power, rate, or the like, and any other suitable information for estimating a channel and communicating via the channel. In various embodiments, the memory 1408 can include one or more local endpoint applications 1410, which may seek to communicate with other endpoint applications, services, etc., on the communication device 1400 and/or other communication devices (not shown) through a distributed bus module 1430. The memory 1408 can additionally store protocols and/or algorithms associated with estimating and/or utilizing a channel (e.g., performance based, capacity based, etc.).

Those skilled in the art will appreciate that the memory 1408 and/or other data stores described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable PROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). The memory 1408 in the subject systems and methods may comprise, without being limited to, these and any other suitable types of memory.

In various embodiments, the distributed bus module 1430 associated with the communication device 1400 can further facilitate establishing connections with other devices. The distributed bus module 1430 may further comprise a bus node module 1432 to assist the distributed bus module 1430 with managing communications between multiple devices. In various embodiments, the bus node module 1432 may further include an object naming module 1434 to assist the bus node module 1432 in communicating with endpoint applications associated with other devices. Still further, the distributed bus module 1430 may include an endpoint module 1436 to assist the local endpoint applications 1410 in communicating with other local endpoints and/or endpoint applications accessible on other devices through an established distributed bus. In another aspect, the distributed bus module 1430 may facilitate inter-device and/or intra-device communications over multiple available transports (e.g., Bluetooth, UNIX domain-sockets, TCP/IP, Wi-Fi, etc.). Accordingly, in various embodiments, the distributed bus module 1430 and the endpoint applications 1410 may be used to establish and/or join a proximity-based distributed bus over which the communication device 1400 can communicate with other communication devices in proximity thereto using direct device-to-device (D2D) communication.

Additionally, in various embodiments, the communication device 1400 may include a user interface 1440, which may include one or more input mechanisms 1442 for generating inputs into the communication device 1400, and one or more output mechanisms 1444 for generating information for consumption by the user of the communication device 1400. For example, the one or more input mechanisms 1442 may include a key or keyboard, a mouse, a touch-screen display, a microphone, and/or any other suitable means to generate and/or receive data to input to the communication device 1400. Furthermore, according to various embodiments, the one or more output mechanisms 1444 may include a display, an audio speaker, a haptic feedback mechanism, a Personal Area Network (PAN) transceiver, and/or any other suitable means to generate and/or present data to be consumed via the communication device 1400. In the illustrated aspects, the output mechanisms 1444 may include an audio speaker operable to render media content in an audio form, a display operable to render media content in an image or video format and/or timed metadata in a textual or visual form, or other suitable output mechanisms. However, in various embodiments, the communication device 1400 may not include certain input mechanisms 1442 and/or output mechanisms 1444 (e.g., where the communication device 1400 is a headless device such as a computer system or device configured to operate without a monitor, keyboard, and/or mouse).

Furthermore, in various embodiments, the communications device 1400 may include one or more sensors 1450 that can obtain various measurements relating to a local environment associated with the communications device 1400. For example, in various embodiments, the sensors 1450 may include an accelerometer, gyroscope, or other suitable sensors that can obtain measurements that relate to inflicted motion at the communications device 1400. In another example, the sensors 1450 may include appropriate hardware, circuitry, or other suitable devices that can obtain measurements relating to internal and/or ambient temperature, power consumption, local radio signals, lighting, and/or other local and/or ambient environmental variables.

Those skilled in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those skilled in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted to depart from the scope of the various aspects and embodiments described herein.

The various illustrative logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration).

The methods, sequences and/or algorithms described in connection with the aspects disclosed herein may be embodied directly in hardware, in a software module executed by a processor, or in a combination of the two. A software module may reside in RAM, flash memory, ROM, EPROM, EEPROM, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in an IoT device. In the alternative, the processor and the storage medium may reside as discrete components in a user terminal.

In one or more exemplary aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, DSL, or wireless technologies such as infrared, radio, and microwave, then the coaxial cable, fiber optic cable, twisted pair, DSL, or wireless technologies such as infrared, radio, and microwave are included in the definition of a medium. The term disk and disc, which may be used interchangeably herein, includes CD, laser disc, optical disc, DVD, floppy disk, and Blu-ray discs, which usually reproduce data magnetically and/or optically with lasers. Combinations of the above should also be included within the scope of computer-readable media.

While the foregoing disclosure shows illustrative aspects and embodiments, those skilled in the art will appreciate that various changes and modifications could be made herein without departing from the scope of the disclosure as defined by the appended claims. The functions, steps and/or actions of the method claims in accordance with the aspects and embodiments described herein need not be performed in any particular order. Furthermore, although elements may be described above or claimed in the singular, the plural is contemplated unless limitation to the singular is explicitly stated.

What is claimed is:

1. A method for providing a dynamic ad hoc Internet of Things (IoT) gateway, comprising:
exchanging, at a first IoT device, connectivity and capability information with one or more other IoT devices, wherein the first IoT device and the one or more other IoT devices form an IoT subnetwork having a dynamic context;
determining, at the first IoT device, that the first IoT device is assigned to be a gateway node on the IoT subnetwork based at least in part on the exchanged connectivity and capability information and the dynamic context associated with the IoT subnetwork; and
establishing, at the first IoT device, a secure private network coupling the one or more other IoT devices to the assigned gateway node and an external interface from the secure private network for the one or more other IoT devices.

2. The method recited in claim 1, wherein the connectivity and capability information comprises information relating to one or more locations, one or more needed services, one or more offered services, one or more communication interfaces, one or more heuristics, or one or more trust metrics associated with the first IoT device and the one or more other IoT devices.

3. The method recited in claim 1, further comprising:
determining one or more services that are offered on an external network and available via the external interface from the secure private network; and
requesting the one or more services offered on the external network on behalf of the one or more other IoT devices via the external interface.

4. The method recited in claim 1, further comprising:
selectively exposing a portion of the IoT subnetwork via the external interface based on one or more of a trust level associated with an external network in communication with the IoT subnetwork via the assigned gateway node or one or more available services offered on the external network.

5. The method recited in claim 1, further comprising:
determining one or more capabilities associated with the assigned gateway node to advertise via the external interface according to a trust level associated with an external network in communication with the IoT subnetwork via the assigned gateway node.

6. The method recited in claim 1, further comprising:
exposing the IoT subnetwork to an external network, in communication with the assigned gateway node, having a trusted status.

7. The method recited in claim 1, wherein the first IoT device is assigned to be the gateway node based on a voting procedure among the first IoT device and the one or more other IoT devices in response to a determination that the first IoT device and the one or more other IoT devices forming the IoT subnetwork include multiple potential gateways that satisfy one or more criteria to be the gateway node on the IoT subnetwork.

8. The method recited in claim 7, further comprising resigning, by the first IoT device, from being the gateway node in response to the voting procedure resulting in one of the multiple potential gateways other than the first IoT device being elected the gateway node.

9. The method recited in claim 1, further comprising:
facilitating a handoff to a new gateway node for the one or more other IoT other devices in the IoT subnetwork prior to leaving the IoT subnetwork, wherein the one or more other IoT devices trigger a voting procedure to elect the new gateway node in response to the assigned gateway node leaving the IoT subnetwork.

10. The method recited in claim 1, wherein the first IoT device is assigned to be the gateway node based on a static assignment scheme that designates the first IoT device to be the gateway node in the dynamic context associated with the IoT subnetwork.

11. The method recited in claim 1, wherein the first IoT device is assigned to be the gateway node based on a hierarchical assignment scheme that ranks the first IoT device higher than the one or more other IoT devices in the dynamic context associated with the IoT subnetwork.

12. The method recited in claim 1, wherein the first IoT device is assigned to be the gateway node based on a dynamic assignment scheme that comprises sending the dynamic context associated with the IoT subnetwork to a home gateway node on a personal IoT network that includes the IoT subnetwork and receiving information indicating that the first IoT device is assigned to be the gateway node on the IoT subnetwork from the home gateway node.

13. The method recited in claim 1, further comprising:
receiving, from at least one of the one or more other IoT devices coupled to the assigned gateway node, one or more context policies that include functional criteria associated with requesting at least one service over the external interface;
detecting an announcement from an external network indicating that the at least one service is available on the external network; and
requesting the at least one service from the external network in response to determining that the functional criteria included in the one or more context policies received from the at least one IoT device are satisfied.

14. The method recited in claim 1, further comprising:
receiving, from at least one of the one or more other IoT devices coupled to the assigned gateway node, one or more context policies that indicate one or more services available on the at least one IoT device to offer over the external interface; and
advertising the one or more available services indicated in the one or more context policies via the external interface.

15. An Internet of Things (IoT) device, comprising:
a transceiver configured to exchange connectivity and capability information with one or more other IoT devices, wherein the IoT device and the one or more other IoT devices form an IoT subnetwork having a dynamic context; and
one or more processors, coupled to the transceiver, configured to:
determine that the IoT device is assigned to be a gateway node on the IoT subnetwork based at least in part on the exchanged connectivity and capability information and the dynamic context associated with the IoT subnetwork; and
establish a secure private network coupling the one or more other IoT devices to the assigned gateway node and an external interface from the secure private network for the one or more other IoT devices.

16. The IoT device recited in claim 15, wherein the connectivity and capability information comprises information relating to one or more locations, one or more needed services, one or more offered services, one or more communication interfaces, one or more heuristics, or one or more trust metrics associated with the IoT device and the one or more other IoT devices.

17. The IoT device recited in claim 15, wherein the one or more processors are further configured to:
determine one or more services that are offered on an external network and available via the external interface from the secure private network; and
request the one or more services offered on the external network on behalf of the one or more other IoT devices via the external interface.

18. The IoT device recited in claim 15, wherein the one or more processors are further configured to:
selectively expose a portion of the IoT subnetwork via the external interface based on one or more of a trust level associated with an external network in communication with the IoT subnetwork via the assigned gateway node or one or more available services offered on the external network.

19. The IoT device recited in claim 15, wherein the one or more processors are further configured to:
determine one or more capabilities associated with the assigned gateway node to advertise via the external interface according to a trust level associated with an external network in communication with the IoT subnetwork via the assigned gateway node.

20. The IoT device recited in claim 15, wherein the one or more processors are further configured to:
expose the IoT subnetwork to an external network, in communication with the assigned gateway node, having a trusted status.

21. The IoT device recited in claim 15, wherein the IoT device is assigned to be the gateway node based on a voting procedure among the IoT device and the one or more other IoT devices in response to a determination that the IoT device and the one or more other IoT devices forming the IoT subnetwork include multiple potential gateways that satisfy one or more criteria to be the gateway node on the IoT subnetwork.

22. The IoT device recited in claim 21, wherein the transceiver is further configured to transmit a message to resign the IoT device from being the gateway node in response to the voting procedure resulting in one of the multiple potential gateways other than the IoT device being elected the gateway node.

23. The IoT device recited in claim 15, wherein the one or more processors are further configured to facilitate a handoff to a new gateway node for the one or more other IoT other devices in the IoT subnetwork prior to leaving the IoT subnetwork, wherein the one or more other IoT devices are configured to trigger a voting procedure to elect the new gateway node in response to the assigned gateway node leaving the IoT subnetwork.

24. The IoT device recited in claim 15, wherein the IoT device is assigned to be the gateway node based on a static assignment scheme that designates the IoT device to be the gateway node in the dynamic context associated with the IoT subnetwork.

25. The IoT device recited in claim 15, wherein the IoT device is assigned to be the gateway node based on a hierarchical assignment scheme that ranks the IoT device higher than the one or more other IoT devices in the dynamic context associated with the IoT subnetwork.

26. The IoT device recited in claim 15, wherein the IoT device is assigned to be the gateway node based on a dynamic assignment scheme controlled at a home gateway node on a personal IoT network that includes the IoT subnetwork, the home gateway node configured to receive the dynamic context associated with the IoT subnetwork and to send information indicating that the IoT device is assigned to be the gateway node to the IoT subnetwork.

27. The IoT device recited in claim 15, the transceiver is further configured to:
receive, from at least one of the one or more other IoT devices coupled to the assigned gateway node, one or more context policies that include functional criteria associated with requesting at least one service over the external interface; and
receive announcement from an external network indicating that the at least one service is available on the external network, wherein the one or more processors are further configured to request the at least one service from the external network in response to the functional criteria received from the at least one IoT device satisfying the one or more context policies associated with requesting the at least one service.

28. The IoT device recited in claim 15, wherein the transceiver is further configured to:
receive, from at least one of the one or more other IoT devices coupled to the assigned gateway node, one or more context policies that indicate one or more services available on the at least one IoT device to offer over the external interface; and
advertise the one or more available services indicated in the one or more context policies via the external interface.

29. An apparatus, comprising:
means for exchanging connectivity and capability information with one or more Internet of Things (IoT) devices, wherein the apparatus and the one or more IoT devices form an IoT subnetwork having a dynamic context;
means for determining that the apparatus is assigned to be a gateway node on the IoT subnetwork based at least in part on the exchanged connectivity and capability information and the dynamic context associated with the IoT subnetwork; and
means for establishing a secure private network coupling the one or more IoT devices to the assigned gateway node and an external interface from the secure private network for the one or more IoT devices.

30. A computer-readable storage medium having computer-executable instructions recorded thereon, wherein executing the computer-executable instructions on an Internet of Things (IoT) device causes the IoT device to:
exchange connectivity and capability information with one or more other IoT devices, wherein the IoT device and the one or more other IoT devices form an IoT subnetwork having a dynamic context;
determine that the IoT device is assigned to be a gateway node on the IoT subnetwork based at least in part on the exchanged connectivity and capability information and the dynamic context associated with the IoT subnetwork; and
establish a secure private network coupling the one or more other IoT devices to the assigned gateway node and an external interface from the secure private network for the one or more other IoT devices.
